(19) United States
(12) Patent Application Publication
(10) Pub. No.: US 2016/0055584 A1
(43) Pub. Date: Feb. 25, 2016

(54) Margin Determination for Products Based on Currency Pairs

(71) Applicant: Chicago Mercantile Exchange, Inc., Chicago, IL (US)

(72) Inventors: Jingbin Yin, Naperville, IL (US); Ivaylo D. Nikolov, Chicago, IL (US); Jalpan Shah, Chicago, IL (US)

(21) Appl. No.: 14/931,304

(22) Filed: Nov. 3, 2015

Related U.S. Application Data
(63) Continuation of application No. 13/715,097, filed on Dec. 14, 2012, now abandoned.

(51) Int. Cl. G06Q 40/04

(52) U.S. Cl. CPC G06Q 40/04

(57) ABSTRACT

A performance bond contribution applicable to a holding in one or more products based on a currency pair may be determined, at least in part, based on volatility values and a volatility floor value. A performance bond contribution applicable to a holding in one or more products based on a third currency pair that includes first and third currencies may be determined using a series of rates. That series of rates may be created, at least in part, based on a series of rates applicable to a first currency pair that includes the first currency and a second currency and a series of rates applicable to a second currency pair that includes the third currency and the second currency. A performance bond contribution applicable to a product based on a pegged component currency pair may be determined using hypothetical portfolios.

### CROSS REFERENCE TO RELATED APPLICATIONS

This application is a continuation of U.S. application Ser. No. 13/715,097, titled “Margin Determination for Products Based on Currency Pairs” and filed Dec. 14, 2012, which application is incorporated by reference herein.

### BACKGROUND

In many financial markets, holders of positions in traded assets are required to maintain a minimum balance of cash or other security as a “margin” or performance bond. This performance bond may be used to reduce the risk to other market participants of losses associated with the position holder failing to fulfill its obligations. If a holder of a portfolio defaults, the performance bond for that portfolio can be used to reduce losses resulting from the holder no longer being able to cover its positions. There remains a need for improved systems and techniques to calculate performance bond values associated with various types of products that are based on currency pairs.

### SUMMARY

This Summary is provided to introduce a selection of concepts in a simplified form that are further described below in the Detailed Description. This Summary is not intended to identify key or essential features of the invention.

In at least some embodiments, a performance bond may be applicable to holdings in one or more products based on a currency pair. A series of volatility values may be calculated and used in conjunction with a volatility floor value. A performance bond contribution may be determined, at least in part, based on the volatility values and the volatility floor value. In at least some such embodiments, a plurality of shocked rates may be generated based at least in part on exchange rate data for the currency pair, the plurality of volatilities, and the volatility floor value. The plurality of shocked rates may be used to create a plurality of shocked returns, and the performance bond contribution may be determined, based at least in part, on the shocked returns.

In at least some embodiments, a performance bond contribution may be applicable to holdings in one or more products based on a third currency pair that includes first and third currencies. A first series of rates may be generated for a first currency pair that includes the first currency and a second currency. A second series of rates may be generated for a second currency pair that includes the third currency and the second currency. A third series of rates may be generated based at least in part on the first and second series of rates. The performance bond contribution may be calculated based at least in part on the third series of rates.

In at least some embodiments, a performance bond contribution may be applicable to a product that is based on a pegged component currency pair. The pegged component currency pair may comprise a pegged currency and a non-pegged currency. The pegged currency may have a value pegged to a value of a reference currency. The reference currency may be different from the non-pegged currency. Data representing first and second hypothetical portfolios may be generated. The first hypothetical portfolio may include a hypothetical holding in a product based on a currency pair that comprises the non-pegged currency and the reference currency. The second hypothetical portfolio may comprise a hypothetical holding in a product based on a currency pair that comprise the non-pegged currency and the reference currency. A performance bond contribution applicable to a portfolio that includes the first hypothetical portfolio may be calculated using one method and a performance bond contribution applicable to a portfolio that includes the second hypothetical portfolio may be calculated using a different method. The two calculated performance bond contributions may then be combined.

Embodiments include, without limitation, methods for determining performance bond values, computer systems configured to perform such methods, and computer-readable media storing instructions that, when executed, cause a computer system to perform such methods.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1A shows an exemplary trading network environment for implementing trading systems and methods according to at least some embodiments.

FIGS. 1B through 5 are flow charts showing steps performed in methods according to at least some embodiments.

### DETAILED DESCRIPTION

In the following description of various embodiments, reference is made to the accompanying drawings, which form a part hereof, and in which various embodiments are shown by way of illustration. It is to be understood that there are other embodiments and that structural and functional modifications may be made. Embodiments of the present invention may take physical form in certain parts and steps, examples of which will be described in detail in the following description and illustrated in the accompanying drawings that form a part hereof.

Various embodiments may comprise a method, a computer system, and/or a computer program product. Accordingly, one or more aspects of one or more of such embodiments may take the form of an entirely hardware embodiment, an entirely software embodiment and/or an embodiment combining software and hardware aspects. Furthermore, such aspects may take the form of a computer program product stored by one or more non-transitory computer-readable storage media having computer-readable program code, or instructions, embodied in or on the storage media. The term “computer-readable medium” or “computer-readable storage medium” as used herein includes not only a single medium or single type of medium, but also a combination of one or more media and/or types of media. Such a non-transitory computer-readable medium may store computer-readable instructions (e.g., software) and/or computer-readable data (i.e., information that may or may not be executable). Any suitable computer readable media may be utilized, including various types of non-transitory computer readable storage media such as hard disks, CD-ROMs, optical storage devices, magnetic storage devices, FLASH memory and/or any combination thereof. The term “computer-readable medium” or “computer-readable storage medium” could also include an integrated circuit or other device having hard-coded instructions (e.g., logic gates) that configure the device to perform one or more operations.

Aspects of method steps described in connection with one or more embodiments may be executed by one or more processors associated with a computer system (such as exchange computer system 100 and/or other computers described below). As used herein, a “computer system” could be a single computer or could comprise multiple computers. When a computer system comprising multiple computers performs a method, various steps could be performed by different ones of those multiple computers. Processors of a computer system may execute computer-executable instructions stored on non-transitory computer-readable media. Embodiments may also be practiced in a computer system forming a distributed computing environment, with tasks performed by remote processing devices that are linked through a communications network. In a distributed computing environment, program modules may be located in both local and remote computer storage media including memory storage devices.

### Exemplary Operating Environment

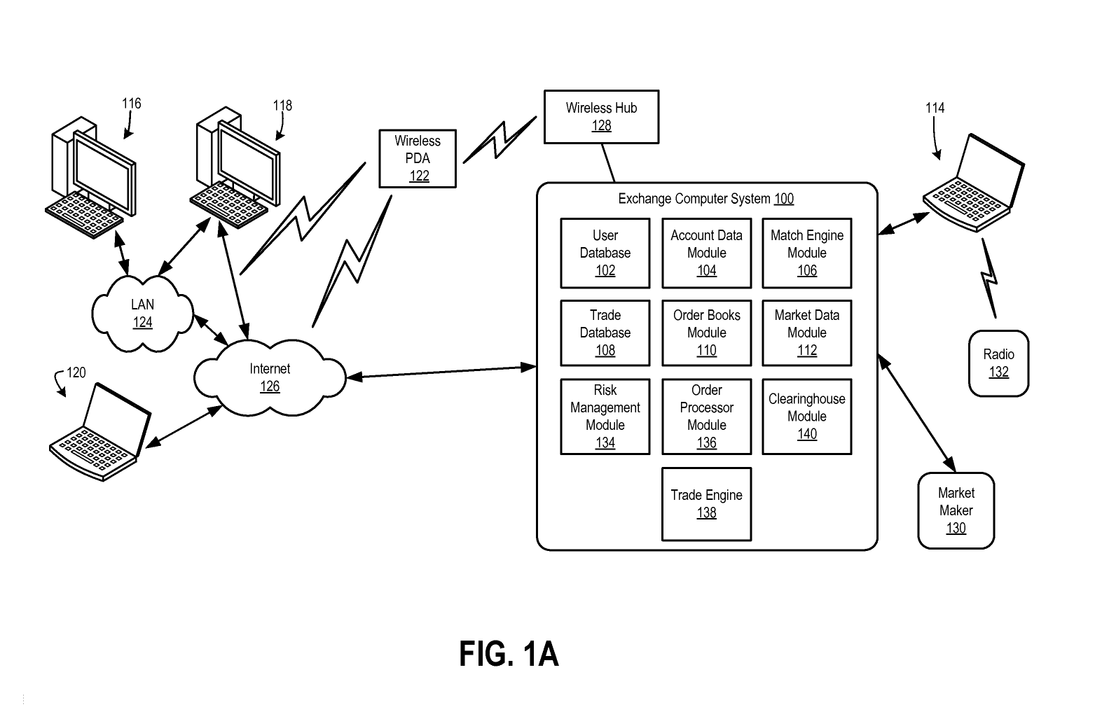

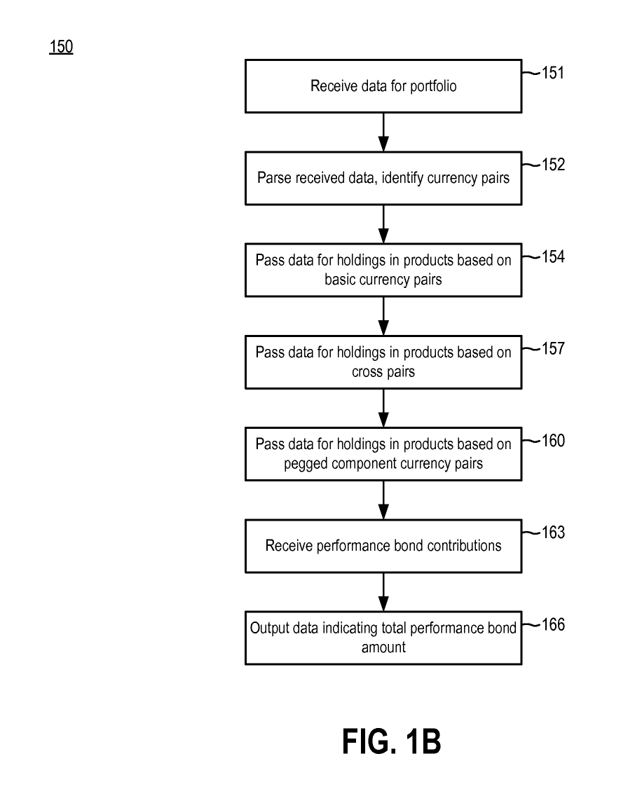

Aspects of at least some embodiments can be implemented with computer systems and computer networks that allow users to communicate trading information. An exemplary trading network environment for implementing trading systems and methods according to at least some embodiments is shown in FIG. 1A. The implemented trading systems and methods can include systems and methods, such as are described herein, that facilitate trading and other activities associated with financial products based on currency pairs.

Computer system 100 can be operated by a financial product exchange and configured to perform operations of the exchange for, e.g., trading and otherwise processing various financial products. Financial products of the exchange may include, without limitation, futures contracts, options on futures contracts (“futures contract options”), and other types of derivative contracts. Financial products traded or otherwise processed by the exchange may also include over-the-counter (OTC) products such as OTC forwards, OTC options, etc.

Computer system 100 receives orders for financial products, matches orders to execute trades, transmits market data related to orders and trades to users, and performs other operations associated with a financial product exchange. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match prices and other parameters of bid and offer orders. Match engine module 106 may be implemented with software that executes one or more algorithms for matching bids and offers.

A trade database 108 may be included to store information identifying trades and descriptions of trades. In particular, a trade database may store information identifying the time that a trade took place and the contract price. An order book module 110 may be included to store prices and other data for bid and offer orders, and/or to compute (or otherwise determine) current bid and offer prices. A market data module 112 may be included to collect market data, e.g., data regarding current bids and offers for futures contracts, futures contract options and other derivative products. Module 112 may also prepare the collected market data for transmission to users. A risk management module 134 may be included to compute and determine a user's risk utilization in relation to the user's defined risk thresholds. An order processor module 136 may be included to decompose delta based and bulk order types for further processing by order book module 110 and match engine module 106.

A clearinghouse module 140 may be included as part of exchange computer system 100 and configured to carry out clearinghouse operations. Module 140 may receive data from and/or transmit data to trade database 108 and/or other modules of computer system 100 regarding trades of futures contracts, futures contracts options, OTC options and contracts, and other financial products. Clearinghouse module 140 may facilitate the financial product exchange acting as one of the parties to every traded contract or other product. For example, computer system 100 may match an offer by party A to sell a financial product with a bid by party B to purchase a like financial product. Module 140 may then create a financial product between party A and the exchange and an offsetting second financial product between the exchange and party B. As another example, module 140 may maintain margin data with regard to clearing members and/or trading customers. As part of such margin-related operations, module 140 may store and maintain data regarding the values of various contracts and other instruments, determine mark-to-market and final settlement amounts, confirm receipt and/or payment of amounts due from margin accounts, confirm satisfaction of final settlement obligations (physical or cash), etc. As discussed in further detail below, module 140 may determine values for performance bonds associated with trading in products based on various types of currency pairs.

Each of modules 102 through 140 could be separate software components executing within a single computer, separate hardware components (e.g., dedicated hardware devices) in a single computer, separate computers in a networked computer system, or any combination thereof (e.g., different computers in a networked system may execute software modules corresponding more than one of modules 102-140).

Computer device 114 is shown directly connected to exchange computer system 100. Exchange computer system 100 and computer device 114 may be connected via a Ti line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may implement one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics, radio links or other media.

A wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1A also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet. Computers 116, 118 and 120 may communicate with each other via the Internet 126 and/or LAN 124.

One or more market makers 130 may maintain a market by providing constant bid and offer prices for a derivative or security to exchange computer system 100. Exchange computer system 100 may also include trade engine 138. Trade engine 138 may, e.g., receive incoming communications from various channel partners and route those communications to one or more other modules of exchange computer system 100.

One skilled in the art will appreciate that numerous additional computers and systems may be coupled to exchange computer system 100. Such computers and systems may include, without limitation, additional clearing systems (e.g., computer systems of clearing member firms), regulatory systems and fee systems.

The operations of computer devices and systems shown in FIG. 1A may be controlled by computer-executable instructions stored on non-transitory computer-readable media. For example, computer device 116 may include computer-executable instructions for receiving market data from exchange computer system 100 and displaying that information to a user. As another example, clearinghouse module 140 and/or other modules of exchange computer system 100 may include computer-executable instructions for performing operations associated with determining performance bond contributions associated with holdings in products that are based on various types of currency pairs.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1A may be connected by numerous alternative topologies.

### Exemplary Embodiments

In at least some embodiments, exchange computer system 100 (or “system 100”) receives, stores, generates and/or otherwise and processes data so as to determine values of performance bonds that are associated with holdings in various types of financial products. A performance bond, also known as a “margin,” is typically calculated by an exchange, by a clearinghouse or by some other market entity to help reduce risk associated with a trader failing to fulfill obligations related to a particular asset or group of assets. A performance bond may represent a minimum amount of funds that must be deposited by a customer with a broker, by a broker with a clearinghouse member and/or by a clearinghouse member with a clearinghouse or exchange. These funds may then be used, e.g., to help assure that losses associated with trading positions can be covered.

Various financial products traded through system 100 are based on currency pairs. In particular, the relative values of two currencies in a currency pair may be used as a measure of obligations (or potential obligations) of one or more parties to a financial product. For example, a foreign exchange (“FX”) forward contract may obligate a first party to pay a certain amount of a first currency on a specified future date in return for a specified quantity of a second currency. Other types of financial products that can be based on a currency pair include, without limitation, a futures contract option, a futures contract, an OTC option, an interest rate swap, etc. Currencies of numerous countries or other governmental entities can be paired. Typically, a value (or exchange rate) for a currency pair is quoted using ISO (International Standards Organization) three letter codes for the two currencies in question. The codes for the two currencies are often ordered by placing the code for the base (or transaction) currency first and the code for the quote (or counter) currency second. For example, a quote of EURUSD 1.35 may refer to an exchange rate of one Euro for 1.35 U.S. Dollars.

FX forward contacts, FX futures contracts and other products based on currency pairs may have differing durations, also known as tenors. For example, one type of FX forward contract having a tenor of one month may require payment in USD for a specified quantity of EUR on a date one month after entry into that FX forward contract. Another type of FX forward contract may require payment in USD for the same quantity of EUR, but have a tenor of one year.

For purposes of the following description, certain terminology is adopted to conveniently refer to several categories of currency pairs. For example, and as used herein, a “basic currency pair” is pair in which either the base or quote currency is a primary currency, and in which the currency pair is not a cross pair (described below) or a pegged component currency pair (also described below). In at least some embodiments, the primary currency is US dollars (USD). A “cross pair” is a currency pair in which neither the base or quote currency is the primary currency (e.g., where neither currency is USD), and in which the currency pair is not a pegged component currency pair. A “pegged component currency pair” is a pair in which either the quote or the base currency has a value that is artificially fixed with regard to reference currency. The reference currency may be a component of the pegged component currency pair (i.e., it may be the base or quote currency), or it may be a third currency.

FIG. 1B is a flow chart showing steps of a method 150, performed by exchange computer system 100 in at least some embodiments, when determining a performance bond amount for a portfolio that includes financial products based on currency pairs. For convenience, the steps of method 150 and of other methods disclosed herein may described using generic currencies and/or currency pairs. For instance, AAAUSD refers to a pairing of a generic currency AAA with USD. AAA could be Euros (EUR), Canadian dollars (CAD), Japanese Yen (JPY) or any other currency.

In some embodiments, the steps of method 150 and other methods described herein are performed by clearinghouse module 140 of exchange computer system 100. In other embodiments, some or all of the steps of one or more of these methods may be performed by other modules of system 100. In still other embodiments, some or all steps of one or more of these methods may be performed by one or more computer systems separate from exchange computer system 100.

In step 151, module 140 receives data for a portfolio that includes products (e.g., forward contracts) based on currency pairs. The received data may identify positions (holdings) in one or more products. For example, the portfolio may include holdings in products based on one or more basic currency pairs (e.g., one or more products based on a first basic currency pair, one or more products based on a second basic currency pair, etc.). The portfolio may also or alternatively include holdings in products based on one or more cross pairs and/or in products based on one or more pegged component currency pairs.

In step 152, module 140 parses the received data and identifies the currency pairs on which each of the currency pair products in the portfolio holdings is based. Based on the currency pairs identified, module 140 then determines which method(s) to use for calculating contribution(s) to a performance bond for the portfolio. For portfolio holdings based on basic currency pairs, module 140 may use a first method to calculate a contribution to the portfolio performance bond for the holdings based on basic currency pairs. For portfolio holdings based on cross pairs, module 140 may use a second method to calculate a contribution to the portfolio performance bond. For portfolio holdings based on pegged component currency pairs, module 140 may use a third method to calculate a contribution to the portfolio performance bond.

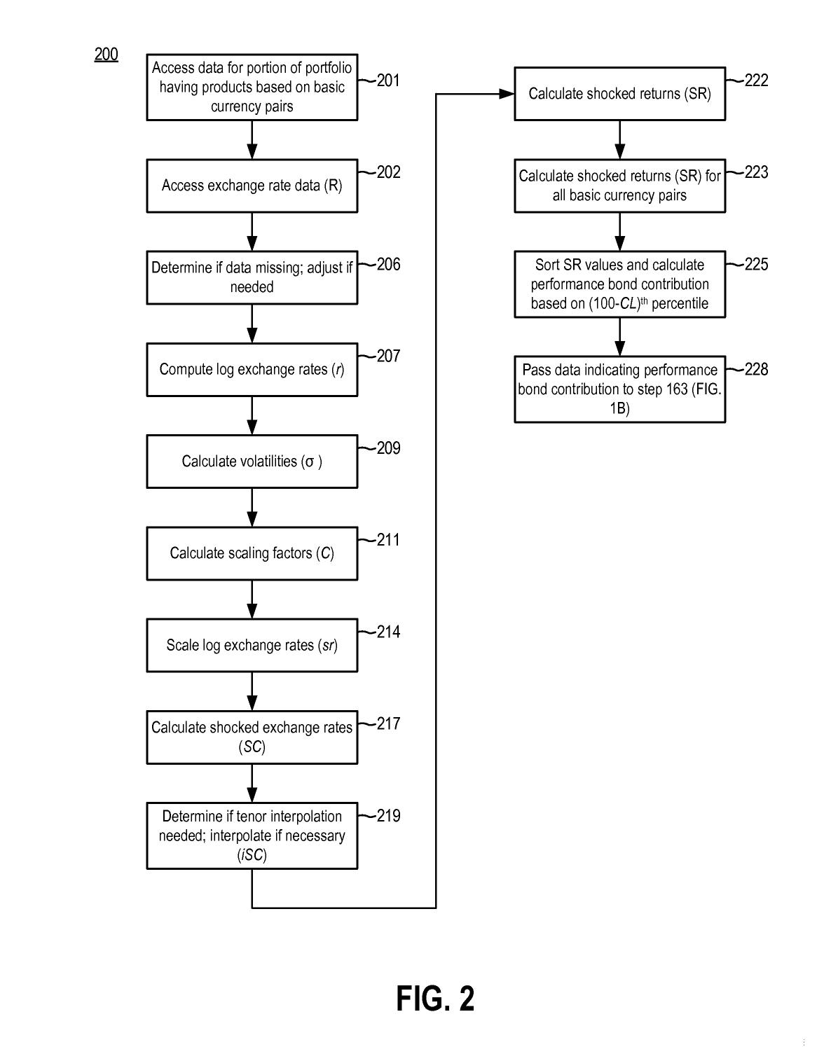

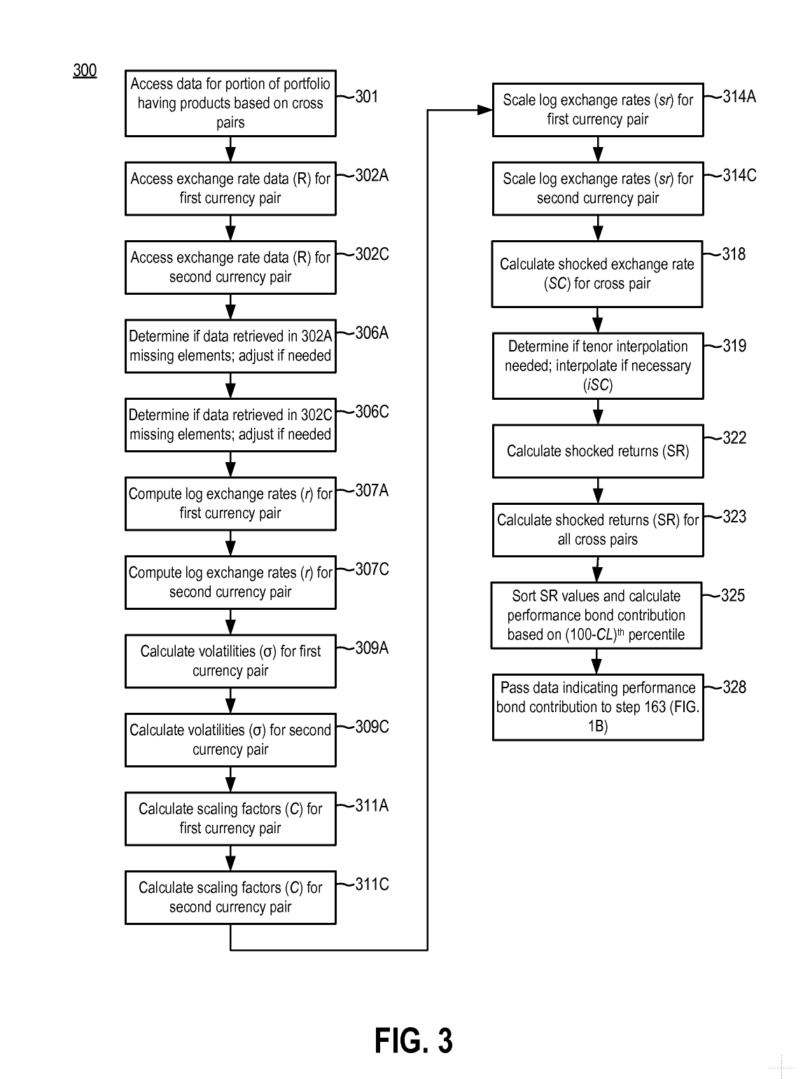

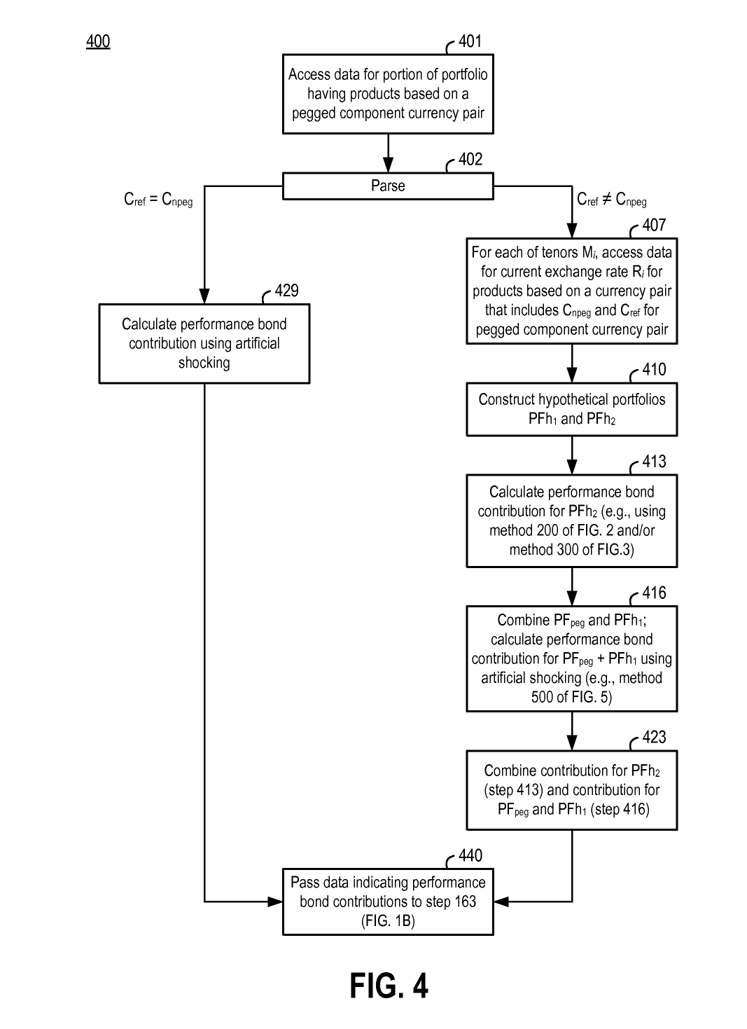

In step 154, module 140 passes data regarding portfolio holdings in products based on basic currency pairs to one or more subroutines that will calculate a performance bond contribution. FIG. 2 is a flow chart of a method 200 performed by module 140 when determining a performance contribution for such holdings according to at least some embodiments.

In step 201, module 140 accesses the data passed in step 154 of method 150. The accessed data identifies holdings in one or more financial products that are based on one or more basic currency pairs. In some embodiments, and as described above, USD is either the quote currency (AAAUSD) or the base currency (USDAAA) of all basic currency pairs.

The data accessed in step 201 may further indicate the extent of positions in one or more products. For example, and for each type of product in the portfolio, the subject portfolio data may indicate the number of products held, the notional amount of each product (e.g., the amount of currency AAA required to be delivered under an AAAUSD FX forward contract), etc. The subject portfolio data may further indicate the nature of the portfolio holder's position in each product. For example, the holder of portfolio A may have a long position in a first product and a short position in a second product (or vice versa), may have long positions in both products, or may have short positions in both products.

Module 140 then performs steps 202 through 222 of method 200 with regard to each basic currency pair identified in the data received in step 201. The steps are performed separately with regard to each identified basic currency pair. For example, assume the data in step 201 identified two basic currency pairs. Module 140 performs step 202 with regard to data for the first basic currency pair and separately performs step 202 with regard to data for the second basic currency pair. Module 140 then performs step 206 for the first basic currency pair using the output of step 202 with regard to the first basic currency pair and separately performs step 206 for the second basic currency pair using the output of step 202 with regard to the second basic currency pair. This pattern would then continue for steps 207-222.

In step 202, module 140 accesses exchange rate data. The accessed exchange rate data may include exchange rates for each of multiple tenors and each of multiple dates. In some embodiments, step 202 may include retrieving the exchange rate data from an external source and storing that exchange rate data. Such data may be obtained from various commercial services (e.g., from the Closing Spot Rates service of WM/Reuters). In other embodiments, such data may have been previously obtained and stored, and module 140 simply accesses that stored data when performing method 200.

In some embodiments, the exchange rate data for a currency pair may comprise a matrix of the following form:

$$[ \begin{matrix}Rate ( Date 1 , Tenor 1 ) & Rate ( Date 1 , Tenor 2 ) & … & Rate ( Date 1 , Tenor y ) \\ Rate ( Date 2 , Tenor 1 ) & Rate ( Date 2 , Tenor 2 ) & … & Rate ( Date 2 , Tenor y ) \\ ⋮ & ⋮ & ⋱ & ⋮ \\ Rate ( Date x , Tenor 1 ) & Rate ( Date x , Tenor 2 ) & … & Rate ( Date x , Tenor y )\end{matrix} ]$$

Each row of the matrix corresponds to a particular date. Each column of the matrix corresponds to a particular tenor. Each element of the matrix represents an exchange rate as of the date corresponding to the element row and for products having the tenor corresponding to the element column. The tenor of each element is relative to the date of the row in which the element is located. If the basic currency pair is AAAUSD, each of the elements in the above matrix may represent an AAAUSD exchange rate as of a specific date (e.g., a designated time on a specific date) and for AAAUSD-based products having a specific tenor relative to that specific date. If the basic currency pair is USDAAA, each of the elements in the above matrix may represent an USDAAA exchange rate as of a specific date and for USDAAA-based products having a specific tenor relative to that specific date.

There are approximately 1260 business days in a five year period. As explained in further detail below, some embodiments employ calculations in which a value applicable to a particular date is based in part on data applicable to a date l days earlier. So that there will be sufficient rate data to support such calculations for 1260 days, a rate matrix according to at least some embodiments may include elements for 1260+l days and y tenors:

$$[ \begin{matrix}{R}_{1 , 1} & {R}_{1 , 2} & … & {R}_{1 , y} \\ {R}_{2 , 1} & {R}_{2 , 2} & … & {R}_{2 , y} \\ ⋮ & ⋮ & ⋱ & ⋮ \\ {R}_{1260 + l , 1} & {R}_{1260 + l , 2} & … & {R}_{1260 + l , y}\end{matrix} ]$$

In some embodiments, l=5 and y=9. In such embodiments, a rate matrix may include elements for 1265 days (e.g., x=1260+5=1265) and for nine tenors (e.g., y=9):

$$[ \begin{matrix}{R}_{1 , 1} & {R}_{1 , 2} & … & {R}_{1 , 9} \\ {R}_{2 , 1} & {R}_{2 , 2} & … & {R}_{2 , 9} \\ ⋮ & ⋮ & ⋱ & ⋮ \\ {R}_{1265 , 1} & {R}_{1265 , 2} & … & {R}_{1265 , 9}\end{matrix} ]$$

The above matrix represents a five year and five day history of exchange rates, for products with nine tenors, for a specific currency pair. The bottom row (x=1265 in the current example) represents exchange rates for the current trading day (T). The lengths of the tenors increase from left to right. For example, tenor 1 may be 0 days and tenor 9 may be 2 years. A 1265 day, nine tenor exchange rate matrix is merely one example. In other embodiments, an exchange rate matrix may have data for more or fewer dates (rows) and more or fewer columns (tenors). For convenience, the following description of method 200 assumes an embodiment in which l=5 and in which y=9. Persons of ordinary skill will appreciate, upon reviewing the totality of this description, how method 200 may be modified (e.g., how forms of matrices might vary) in embodiments in which l and/or y has a different value and/or in which more or less than five years' data is employed.

In step 206, module 140 determines if any rate data accessed in step 202 is missing any elements. For example, markets for a currency may be closed on certain non-weekend days because of holidays or other events that interrupted trading on a particular day. If rate data is missing for a particular date and tenor combination, data for the previous date and the same tenor is used. For example, if rate data was unavailable for date 1000, tenor 5, the rate data for date 999, tenor 5 could be used for date 1000, tenor 5.

In step 207, and using data from step 206, module 140 calculates log exchange rate data. The log exchange rate for each date and tenor may be computed as a logarithm of the ratio of the exchange rates on that date and the date corresponding to the l^{th} business day before that day. In particular, and using data from an exchange rate matrix as checked and adjusted in step 206, module 140 generates a matrix of log exchange rate values according to equation 1:

$${r}_{x , y} {\vert}_{x > l} = log ( \frac{{R}_{x , y}}{{R}_{x - l , y}} ) \qquad Equation 1$$

In at least some embodiments, and as indicated above, l has a value of 5. At the conclusion of step 207, and for each identified basic currency pair, the result is a log exchange rate matrix of the following form:

$$[ \begin{matrix}{r}_{6 , 1} & {r}_{6 , 2} & … & {r}_{6 , 9} \\ {r}_{7 , 1} & {r}_{7 , 2} & … & {r}_{7 , 9} \\ ⋮ & ⋮ & ⋱ & ⋮ \\ {r}_{1265 , 1} & {r}_{1265 , 2} & … & {r}_{1265 , 9}\end{matrix} ]$$

For the current example where l=5, the above matrix thus represents a 1260 day (five year) set of log exchange rates for tenors 1 through 9. For consistency with notation previously used for the “R” matrices, the row numbering in the above and subsequent matrices is begins at “6.” It is to be understood that, for embodiments in which l has a different value, row numbering might begin at l+1 and end at, e.g., 1260+l.

In step 209, and using data from step 207, exponentially weighted moving average (EWMA) volatility forecasting is utilized. In particular, module 140 calculates a matrix of volatilities σ by using an EWMA model according to equation 2:

σ_{x,y}|_{x>i+1}=\sqrt{(1−λ)r_{x-1,y}²+λσ_{x-1,y}²} Equation 2:
where:
   σ_{x,y} is the volatility forecast at date x for products with tenor y,
   r_{x,y} is the log exchange rate for date x and tenor y,
   r_{x-1,y} is the log exchange rate for date x−1 and tenor y, and
λ is a time decay coefficient of the historical log exchange rates.
   In at least some embodiments, λ has a value of 0.97. Values for σ for date x=l+1 may be seeded by performing EWMA calculations on earlier data (e.g., for a one year prior to the time of the seeded σ values), with the seeded values for those calculations derived from squares of log exchange rates. At the conclusion of step 209, and for each identified basic currency pair, the result is a volatility matrix of the following form:

$$[ \begin{matrix}{σ}_{6 , 1} & {σ}_{6 , 2} & … & {σ}_{6 , 9} \\ {σ}_{7 , 1} & {σ}_{7 , 2} & … & {σ}_{7 , 9} \\ ⋮ & ⋮ & ⋱ & ⋮ \\ {σ}_{1265 , 1} & {σ}_{1265 , 2} & … & {σ}_{1265 , 9}\end{matrix} ]$$

In step 211, module 140 calculates a matrix of scaling factors C using the volatilities a from step 209 and a volatility floor value σ_{Floor} according to equation 3:

$${C}_{x , y} {\vert}_{x > l} = \frac{max ( {σ}_{T , y} , {σ}_{Floor} )}{{σ}_{x , y}} \qquad Equation 3$$

where:
   σ_{T,y} is the volatility for the current date and tenor y (i.e., the σ value for tenor y on the bottom row of the volatility matrix).
      In at least some embodiments, a value for σ_{Floor} is obtained by reviewing all values of a and setting σ_{Floor} to a value equal to a designated percentile (e.g., the 25th percentile) of those values. At the conclusion of step 211, and for each identified basic currency pair, the result is a scaling factor matrix of the following form:

$$[ \begin{matrix}{C}_{6 , 1} & {C}_{6 , 2} & … & {C}_{6 , 9} \\ {C}_{7 , 1} & {C}_{7 , 2} & … & {C}_{7 , 9} \\ ⋮ & ⋮ & ⋱ & ⋮ \\ {C}_{1265 , 1} & {C}_{1265 , 2} & … & {C}_{1265 , 9}\end{matrix} ]$$

In step 214, and using data from steps 207 and 211, module 140 scales the elements of the log exchange rate matrix by the elements of the scaling factor matrix according equation 4:

sr_{x,y}=r_{x,y}*C_{x,y} Equation 4:

At the conclusion of step 214, and for each identified basic currency pair, the result is a scaled log exchange rate matrix of the following form:

$$[ \begin{matrix}{sr}_{6 , 1} & {sr}_{6 , 2} & … & {sr}_{6 , 9} \\ {sr}_{7 , 1} & {sr}_{7 , 2} & … & {sr}_{7 , 9} \\ ⋮ & ⋮ & ⋱ & ⋮ \\ {sr}_{1265 , 1} & {sr}_{1265 , 2} & … & {sr}_{1265 , 9}\end{matrix} ]$$

In step 217, and using data from step 214, module 140 calculates “shocked” exchange rates. For each of tenors 1 through y, data for each date extending backward to date x=l+1 (e.g., to date x=6) is treated as a separate scenario in which current exchange rate data is “shocked.” The resulting rates form columns of a matrix in which elements are generated according to equation 5:

SC_{x,y|x>l}=R_{T,y}*exp(sr_{x,y}) Equation 5:
where:
   R_{T,y} is the value of the exchange rate for tenor y on the current date, i.e., from the bottom row of the exchange rate matrix of step 202 or step 206.
      At the conclusion of step 217, and for each identified basic currency pair, the result is a shocked exchange rate matrix of the following form:

$$[ \begin{matrix}{SC}_{6 , 1} & {SC}_{6 , 2} & … & {SC}_{6 , 9} \\ {SC}_{7 , 1} & {SC}_{7 , 2} & … & {SC}_{7 , 9} \\ ⋮ & ⋮ & ⋱ & ⋮ \\ {SC}_{1265 , 1} & {SC}_{1265 , 2} & … & {SC}_{1265 , 9}\end{matrix} ]$$

In step 219, module 140 determines if elements in the shocked exchange rate matrix of step 217 must be interpolated to account for mismatches between the tenors in the shocked exchange rate matrix and the tenors of products in the portfolio. For example, the tenor of a portfolio product may lie somewhere between two tenors in a shocked exchange rate matrix. If interpolation is required for any of the portfolio products, a shocked rate for that tenor y′ can be created according to equation 6 and using data from step 217:

$${iSC}_{x , {y}^{′}} {\vert}_{x > l} = {SC}_{x , y} * {( \frac{{SC}_{x , y + 1}}{{SC}_{x , y}} )}^{\frac{t ( {y}^{′} ) - t ( y )}{t ( y + 1 ) - t ( {y}^{′} ) )}} \qquad Equation 6$$

where:
   iSC_{x,y′} is the shocked exchange rate for date x and tenor y′, where y′ lies between two tenors y and y+1 of the shocked exchange rate matrix,
t(y) is the time from the current date until the maturity date associated with tenor y,
t(y′) is the time from the current date until the maturity date associated with tenor y′, and
t(y+1) is the time from the current date until the maturity date associated with tenor y+1.

In step 222, and for scenarios corresponding to each of rows x=l+1 (e.g., x=6) through T (e.g., x=1265) in the above described matrices, module 140 calculates shocked returns (SR) for the subject portfolio. The shocked return for any given scenario may be a loss, a gain or a zero return. For each identified basic currency pair, module 140 calculates the shocked returns (in U.S. dollars) for all portfolio products based on that currency pair according to equation 7:

$${SR}_{x} ( bcp ) = {\sum }_{j = 1}^{n} [ {N}_{j} * ( {iSC}_{x , y ( j )} - {iR}_{T , y ( j )} ) * CF * {DF}_{x}^{USD} ] \qquad Equation 7$$

where:
   SRₓ(bcp) is the shocked return, corresponding to scenario x, for products in the portfolio based on basic currency pair bcp,
   n is the number of products in the portfolio based on basic currency pair bcp,
   Nⱼ is the notional value of the j^{th} portfolio product based on basic currency pair bcp,
   y(j) is the tenor of that j^{th} portfolio product,
   iSC_{x,y(j)} is the interpolated shocked exchange rate value previously calculated in step 219 (if such interpolation was required) or SC_{x,y} calculated in step 217 (if no interpolation was required, i.e., if y(i) is aligned with a tenor y from the shocked exchange rate matrix),
iR_{T,y(j)} is the current market rate for basic currency pair bcp and for products with tenor y(j), wherein
   if y(j) is aligned with a tenor y of the shocked exchange rate matrix, then iR_{T,y(j)} is equal to R_{T,y} (for that aligned tenor y) from the exchange rate matrix data accessed in step 202 and/or as modified in step 206, and
   if y(j) lies between tenors y and y+1 of the shocked exchange matrix, then iR_{T,y(j)} is equal to

$${R}_{T , y} * {( \frac{{R}_{T , y + 1}}{{R}_{T , y}} )}^{\frac{t ( y ( j ) ) - t ( y )}{t ( y + 1 ) - t ( y ( j ) ) )}}$$

with t(y) being the time from the current date until the maturity date associated with tenor y, t(y(j)) being the time from the current date until the maturity date associated with tenor y(j), and t(y+1) being the time from the current date until the maturity date associated with tenor y+1,
CF is equal to
   1 if USD (or other primary currency) is the quote currency of basic currency pair bcp, or
   1/iSC_{x,y(j)} if USD (or other primary currency) is the base currency of basic currency pair bcp, and
DFₓ^{USD} is a discount factor to account for the time difference between product maturity and the current date (i.e., t(y(j))) [in some embodiments this discount factor may be calculated using monotone convex interpolation of data from a USD overnight indexed swap (OIS) curve].

For each identified basic currency pair, step 222 results in an array of shocked returns, with positive values for SR representing gains and negative values for SR representing losses:

$$[ \begin{matrix}{SR}_{6} ( bcp ) \\ {SR}_{7} ( bcp ) \\ {SR}_{8} ( bcp ) \\ ⋮ \\ {SR}_{1265} ( bcp )\end{matrix} ]$$

In step 223, module 140 sums SR values for each scenario according to equation 8:

$${SR}_{x} = {\sum }_{k = 1}^{u} {SR}_{x} ( {bcp}_{k } ) \qquad Equation 8$$

where:
   SRₓ is a shocked return, corresponding to scenario x, for products in the portfolio corresponding to basic currency pairs 1 through u,
bcpₖ is the k^{th} identified bcp, and
u is the number of identified basic currency pairs.
   Step 223 results in an array of shocked returns that relates to all of the identified products identified in step 201:

$$[ \begin{matrix}{SR}_{6} \\ {SR}_{7} \\ {SR}_{8} \\ ⋮ \\ {SR}_{1265}\end{matrix} ]$$

In step 225, module 140 sorts the SR values in the array of step 223 from highest to lowest, i.e., maximum gain to maximum loss. Within those sorted SR values, module 140 then identifies the value corresponding to a (100−CL)^{th} percentile, where CL is a desired confidence level. In at least some embodiments, CL has a value of 99.7, and module 140 identifies the element in the sorted SR value series representing the 0.3^{rd} percentile of that series. In some embodiments, module 140 may calculate a 0.3^{rd} percentile value from the SR values in a series. In other embodiments, module 140 may select an actual value in the SR series that is closest to or below the 0.3^{rd} percentile. Once module 140 obtains the 0.3^{rd} percentile value for a series, that value is converted to a positive number and designated as the performance bond value contribution for the portfolio holdings identified in the data accessed in step 201. In step 228, data indicating the performance bond contribution amount from step 225 is passed to step 163 of method 150. Step 163 is discussed below. In some embodiments, and as described below, operations of step 225 might be combined with operations of a step 325 of method 300 (FIG. 3).

Returning to FIG. 1B, in step 157 module 140 passes data regarding holdings in products based on cross pairs to one or more subroutines that will calculate a performance bond contribution. As indicated above, a cross pair is a currency pair in which neither currency is the primary currency. For example, if USD is the primary currency, a cross pair AAABBB is a currency pair in which neither AAA nor BBB is USD. In order for a performance bond to more accurately represent risk, it is desirable that a “triangular” relationship exist with regard to a performance bond for AAABBB and performance bonds for currency pairings of USD with elements of the cross pair (e.g., with the pairs AAAUSD and BBBUSD). Moreover, directly shocking a cross pair may result in a performance bond value that less accurately represents risk. In at least some embodiments, module 140 therefore performs additional steps with regard to products based on a cross pair so as to achieve or better approximate the desired triangular relationship.

FIG. 3 is a flow chart showing steps of a method 300 performed by module 140 when determining a performance bond contribution for portfolio holdings based on one or more cross pairs. The following description of method 300 assumes that USD is the primary currency. In other embodiments, another currency might be treated as the primary currency.

In step 301, module 140 accesses the data passed in step 157 of method 150. The accessed data identifies positions in one or more financial products that are based on one or more cross pairs. Module 140 then performs steps 302A through 322 of method 300 with regard to each cross pair identified in the data received in step 301. For convenience, steps 302A through 322 are described by reference to a single cross pair (AAABBB). Persons of ordinary skill will appreciate, upon reviewing the totality of the disclosure, how steps 302A-322 would be separately performed if the data received in step 301 identified multiple cross pairs.

In steps 302A and 302C, module 140 performs operations similar to those of step 202 in method 200. In step 302A, however, module 140 accesses exchange rate data R for a first currency pair (e.g., AAAUSD) formed by the first currency of a cross pair and the primary currency. In step 302C, module 140 accesses exchange rate data R for a second currency pair (e.g., BBBUSD) formed by the second currency of that cross pair and the primary currency. In some embodiments, l=5, the accessed rate data for each of the first currency pair (AAAUSD) and the second currency pair (BBBUSD) includes elements for the same 1265 dates and for the same nine tenors, and the rate data for each currency pair can be represented as a matrix in which x=1265 and y=9. In some embodiments, there may be a mismatch between the dates for which data is available for the first and second currency pair and/or a mismatch between the tenors for which data is available for the first and second currency pair. In some such embodiments, module 140 adjusts the data accessed in steps 302A and 302C so that data for the first and second currency pairs apply to the same dates and tenors. Module 140 may perform such adjustment by, e.g., interpolation using techniques similar to the interpolation techniques described herein.

In step 306A, module 140 performs operations with regard to the exchange rate data accessed in step 302A. In step 306C, module 140 performs operations with regard to the exchange rate data accessed in step 302C. Module 140 may perform the operations of step 306A and of step 306C in a manner similar to those of step 206 of method 200.

In step 307A, and using data from step 306A, module 140 calculates log exchange rates and generates a log exchange rate matrix with regard to the first currency pair (e.g., AAAUSD). In step 307C, and using data from step 306C, module 140 calculates log exchange rates and generates a log exchange rate matrix with regard to the second currency pair (e.g., BBBUSD). Module 140 may perform the operations of step 307A and of step 307C in a manner similar to that described in connection with step 207 of method 200.

In step 309A, and using data from step 307A, module 140 calculates a matrix of volatilities a for the first currency pair (e.g., AAAUSD). In step 309C, and using data from step 307C, module 140 calculates a matrix of volatilities a for second currency pair (e.g., BBBUSD). Module 140 may perform the operations of step 309A and of step 309C in a manner similar to that described in connection with step 209 of method 200.

In step 311A, and using data from step 309A, module 140 calculates scaling factors C for the first currency pair (e.g., AAAUSD). In step 311C, and using data from step 309C, module 140 calculates scaling factors C for second currency pair (e.g., BBBUSD). Module 140 may perform the operations of step 311A and of step 311C in a manner similar to that described in connection with step 211 of method 200.

In step 314A, and using data from steps 307A and 311A, module 140 calculates scaled log exchange rate values for the first currency pair (e.g., AAAUSD). In step 314C, and using data from steps 307C and 311C, module 140 calculates scaled log exchange rate values for the second currency pair (e.g., BBBUSD). Module 140 may perform the operations of step 314A and of step 314C in a manner similar to that described in connection with step 214 of method 200.

In step 318, module 140 creates a scaled return matrix for a cross pair according to equation 9:

SC_{x,y}^{CP1CP2}|_{x>l}=R_{T,y}*exp(sr_{x,y}(CP1USD)−sr_{x,y}(CP2USD)) Equation 9:
where:
   SC_{x,y}^{CP1CP2} is the element of the scaled return matrix, for date x (scenario x) and tenor y, for cross pair CP1CP2 composed of currencies CP1 and CP2 (e.g., AAABBB in the current example),
   R_{T,y} is the current market rate for CP1CP2 cross pair products (e.g., AAABBB products in the current example) with tenor y, which market rate data may be accessed (and retrieved, if not previously retrieved) as part of step 318,
   sr_{x,y}(CP1USD) is the scaled log exchange rate, for date x (scenario x) and tenor y, for first currency pair CP1USD (e.g., AAAUSD in the current example) (from step 314A), and
   sr_{x,y}(CP2USD) is the scaled log exchange rate, for date x (scenario x) and tenor y, for second currency pair CP2USD (e.g., BBBUSD in the current example) (from step 314C).
      In the current example, where x=1265 and y=9 for both the first currency pair AAAUSD and the second currency pair BBBUSD, the result of step 318 is a shocked exchange rate matrix of the following form:

$$[ \begin{matrix}{SC}_{6 , 1}^{AAABBB} & {SC}_{6 , 2}^{AAABBB} & … & {SC}_{6 , 9}^{AAABBB} \\ {SC}_{7 , 1}^{AAABBB} & {SC}_{7 , 2}^{AAABBB} & … & {SC}_{7 , 9}^{AAABBB} \\ ⋮ & ⋮ & ⋱ & ⋮ \\ {SC}_{1265 , 1}^{AAABBB} & {SC}_{1265 , 2}^{AAABBB} & … & {SC}_{1265 , 9}^{AAABBB}\end{matrix} ]$$

In step 319, module 140 determines if elements in the shocked exchange rate matrix from step 318 must be interpolated to account for mismatches between the tenors in that matrix and the tenors of products in the portfolio. If interpolation is required, elements iSC for a tenor y′ can be created in a manner similar to that used in connection with step 219 of method 200.

In step 322, module 140 calculates shocked returns (SR) for products in the portfolio. Module 140 calculates the shocked returns (in U.S. dollars) in step 322 according to equation 10:

$${SR}_{x} ( cp ) = {\sum }_{j = 1}^{n} [ {N}_{j} * ( {iSC}_{x , y ( j )}^{CP 1 CP 2} - {iR}_{T , y ( j )} ) * {SC}_{x , y ( j )}^{CP 2 USD} * {DF}_{x}^{USD} ] \qquad Equation 10$$

where:
   SRₓ(cp) is the shocked return, corresponding to scenario x, for products in the portfolio based on cross pair “cp”,
   n is the number of products in the portfolio based on cross pair “cp”,
   Nⱼ is the notional value of the j^{th} product in the portfolio based on cross pair “cp”,
   y(j) is the tenor of that j^{th} product,
   iSC_{x,y(j)}^{CP1CP2} is the interpolated shocked exchange rate in step 319 (if such interpolation was required) or the value of SC_{x,y} (e.g., SC_{x,y}^{AAABBB} in the current example) calculated in step 318 if no interpolation was required (i.e., if y(j) is aligned with tenor y from the shocked exchange rate matrix),
   iR_{T,y(j)} is the current market rate for CP1CP2 cross pair products (e.g., AAABBB products in the current example) with tenor y(j), which market rate data may be accessed (and retrieved, if not previously retrieved) as part of step 322, and wherein
      if y(j) is aligned with a tenor y of the cross pair cp market rate data, then iR_{T,y(j)} is equal to the current rate (R_{T,y}) for that aligned tenor y, and
      if y(j) lies between tenors y and y+1 of the cross pair cp market rate data, then iR_{T,y(j)} is equal to

$${R}_{T , y} * {( \frac{{R}_{T , y + 1}}{{R}_{T , y}} )}^{\frac{t ( y ( j ) ) - t ( y )}{t ( y + 1 ) - t ( y ( j ) )}}$$

with t(y) being the time from the current date until the maturity date associated with tenor y, t(y(j)) being the time from the current date until the maturity date associated with tenor y(j), and t(y+1) being the time from the current date until the maturity date associated with tenor y+1,
SC_{x,y(j)}^{CP2USD} is obtained or interpolated from data in a matrix calculated in manner similar to that described in connection with step 217 of method 200 and using data from steps 314C and 302C (and/or 306C), where
   if y(j) aligns with a tenor y of that matrix, SC_{x,y(j)}^{CP2USD} is equal to the element of that matrix on row x and in the column of that aligned tenor y, and
   if y(j) lies between tenors y and y+1 of that matrix, SC_{x,y(j)}^{CP2USD} is interpolated from the x,y and x,y+1 elements of that matrix in a manner similar to that used in connection with 219 and 319, and
DFₓ^{USD} is a discount factor as previously described in connection with step 222 of method 200.

For each of the cross pairs cp identified in step 301, step 322 results in an array of shocked returns:

$$[ \begin{matrix}{SR}_{6} ( cp ) \\ {SR}_{7} ( cp ) \\ {SR}_{8} ( cp ) \\ ⋮ \\ {SR}_{1265} ( cp )\end{matrix} ]$$

In step 323, module 140 sums SR values for each scenario according to equation 11:

$${SR}_{x} = {\sum }_{k = 1}^{u} {SR}_{x} ( {cp}_{k} ) \qquad Equation 11$$

where:
   SRₓ is a shocked return, corresponding to scenario x, for products in the portfolio corresponding to cross pairs 1 through u,
   cpₖ is the k^{th} identified cross pair, and
   u is the number of identified cross pairs.

Step 323 results in an array of shocked returns that relates to all of the identified products identified in step 301:

$$[ \begin{matrix}{SR}_{6} \\ {SR}_{7} \\ {SR}_{8} \\ ⋮ \\ {SR}_{1265}\end{matrix} ]$$

In step 325, module 140 sorts the SR values of step 323 from highest to lowest. Within those sorted SR values, module 140 then identifies the loss value corresponding to a (100−CL)^{th} percentile, where CL is a desired confidence level (e.g., 99.7%). Once module 140 obtains the (100−CL)^{th} (e.g., the 0.3^{rd}) percentile value for a series, that value is converted to a positive number and designated as the performance bond value contribution for portfolio holdings identified in the data accessed in step 301. In step 328, data indicating the performance bond contribution amount from step 325 is passed to step 163 of method 150. Step 163 is discussed below.

In some embodiments, operations of step 225 from method 200 (FIG. 2) may be combined with operations of step 325 from method 300 (FIG. 3) when calculating a performance bond for a portfolio that includes one or more products based on basic currency pairs and one or more products based on cross pairs. For example, steps 201 through 223 of method 200 could be performed with regard to portfolio products based on basic currency pairs, resulting in an array of SR values for the basic currency pair products as described in connection with step 223 (e.g., [SR₆(bcp products), SR₇(bcp products), SR₈(bcp products), . . . SR₁₂₆₅(bcp products)]). Steps 301 through 323 of method 300 could be performed with regard to portfolio products based on cross pairs, resulting in an array of SR values for the cross pair products as described in connection with step 323 (e.g., [SR₆(cp products), SR₇(cp products), SR₈(cp products), . . . SR₁₂₆₅(cp products)]). Those two arrays could then be combined by adding each x^{th} element of the basic currency pair SR array to the x^{th} element of the cross pair SR array (e.g., [SR₆=SR₆(bcp products)+SR₆(cp products), SR₇=SR₇(bcp products)+SR₇(cp products), SR₈=SR₈(bcp products)+SR₈(cp products), . . . SR₁₂₆₅=SR₁₂₆₅(bcp products)+SR₁₂₆₅(cp products)]). The SR values of the combined array could then be sorted from highest to lowest, a loss value corresponding to a (100-CL)^{th} percentile identified within those sorted levels, and the (100−CL)^{th} (e.g., the 0.3^{rd}) percentile value converted to a positive number and designated as the performance bond value contribution for portfolio holdings identified in the data accessed in step 201 and in step 301. The data indicating that performance bond contribution could then be passed to step 163 of method 150.

Returning to FIG. 1B, in step 160 module 140 passes data regarding holdings based on pegged component currency pairs to one or more subroutines that will calculate a performance bond contribution. FIG. 4 is a flow chart showing steps of a method 400, performed by module 140 according to at least some embodiments, when determining a performance bond contribution for portfolio holdings in products based on one or more pegged component currency pairs. As used herein. “C_{peg}” refers to the component of a pegged component currency pair having a value pegged to a reference currency C_{ref}. As also used herein, “C_{npeg}” refers to the component of a pegged component currency pair that does not have its value pegged to another currency C_{ref}. For some pegged component currency pairs, C_{ref} may be the same as C_{npeg}. For other pegged component currency pairs, C_{ref} may be different from as C_{npeg}.

In step 401, module 140 accesses the data passed in step 160 of method 150. In step 402, module 140 parses that data. As part of this parsing, module 140 identifies holdings (if any) based on pegged component currency pairs in which C_{ref}=C_{npeg} and holdings (if any) based on pegged component currency pairs in which C_{ref}≠C_{npeg}. For any holdings based on pegged component currency pairs in which C_{ref}=C_{npeg}, module 140 passes data regarding such holdings for further processing in step 429 (described below). For any holdings based on pegged component currency pairs in which C_{ref}≠C_{npeg}, module 140 passes data regarding such holdings to step 407.

For convenience, steps 407 through 416 are described in connection with a portfolio portion having holdings in i products (i≧1) based on a single pegged component currency pair, with each of those products i having a notional Nᵢ and a tenor Mᵢ. If a portfolio included products based on multiple different pegged component currency pairs in which C_{ref}≠C_{npeg}, steps 407-416 could be performed separately with regard to holdings in each of those different pegged component currency pairs. Persons of ordinary skill will appreciate, upon reviewing the totality of the disclosure, how steps 407-416 could be separately performed in such a scenario.

As an example, a portfolio portion for which data is received in step 401 may include holdings in two USDDKK forward contracts. “DKK” is the ISO symbol for the Danish Krone. The Danish Krone is pegged to the Euro (EUR). In this example, the portfolio portion only includes holdings in two products (i=2) that are based on the USDDKK currency pair. The first of those holdings is in a single first product having a notional of Nᵢ=N₁ and a tenor of Mᵢ=M₁. The second of those holdings is in a single second product having a notional of Nᵢ=N₂ and a tenor of Mᵢ=M₂. N₁ may, but need not, be different from N₂ and M₁ may, but need not, be different from M₂. This example portfolio portion can be represented as shown in table 1.

TABLE 1

| Product (i) | Currency pair | Notional | Tenor |
|---|---|---|---|
| 1 | USDDKK | N₁ | M₁ |
| 2 | USDDKK | N₂ | M₂ |

In step 407, using data from step 402 and for each of the tenors Mᵢ, module 140 accesses rate data. That rate data includes the current exchange rate Rᵢ for products based on a currency pair that includes C_{npeg} for the pegged component currency pair and C_{ref} for C_{peg} of the pegged component currency pair. Continuing the previous example, module 140 would obtain exchange rates Rᵢ=R₁ and Rᵢ=R₂ for products based on the EURUSD currency pair and having tenors Mᵢ=M₁ and Mᵢ=M₂. In this example, data accessed in step 407 can be represented as shown in table 2.

TABLE 2

| Tenor | Rate - EURUSD |
|---|---|
| M₁ | R₁ |
| M₂ | R₂ |

In step 410, and using the data from step 407, module 140 constructs two hypothetical portfolios PFh₁ and PFh₂. Hypothetical portfolio PFh₁ includes holdings in i products based on the currency pair that includes C_{npeg} and C_{ref} for the pegged component currency pair. Each of those products has a notional Nᵢ/Rᵢ and a tenor Mᵢ. Hypothetical portfolio PFh₂ also includes holdings in i products based on the currency pair that includes C_{npeg} and C_{ref} for the pegged currency pair. However, each of the products in portfolio PFh₂ has a notional −Nᵢ/Rᵢ and a tenor Mᵢ; PFh₁ is thus opposite to PFh₂. Although a negative notional may not correspond to an actual product, it may nonetheless be used to calculate a performance bond.

Continuing the previous example of tables 1 and 2, exemplary data for hypothetical portfolios PFh₁ and PFh₂ can be represented as shown in tables 3 and 4.

TABLE 3
example PFh₁

| Currency pair | Notional | Tenor |
|---|---|---|
| EURUSD | N₁/R₁ | M₁ |
| EURUSD | N₂/R₂ | M₂ |

TABLE 4
example PFh₂

| Currency pair | Notional | Tenor |
|---|---|---|
| EURUSD | −N₁/R₁ | M₁ |
| EURUSD | −N₂/R₂ | M₂ |

In step 413, module 140 calculates a performance bond contribution for PFh₂ using method 200 or method 300. In step 416, module 140 combines portfolio PFh₁ and the portfolio portion based on a pegged component currency pair (PF_{peg}). In the current example, this would combine the portfolio portion shown in Table 1 with the example PFh₁ shown in Table 3. This combined PF_{peg}+PFh₁ portfolio is equivalent to a portfolio of products based on the currency pair that includes C_{peg} and C_{ref} for the pegged component currency pair. In the current example, the combined PF_{peg}+PFh₁ portfolio is equivalent a portfolio of EURDKK-based products. Module 140 then calculates a performance bond value for this PF_{peg}+PFh₁ portfolio. In some embodiments, module 140 calculates a performance bond value for the PF_{peg}+PFh₁ portfolio using “artificial” shocking.

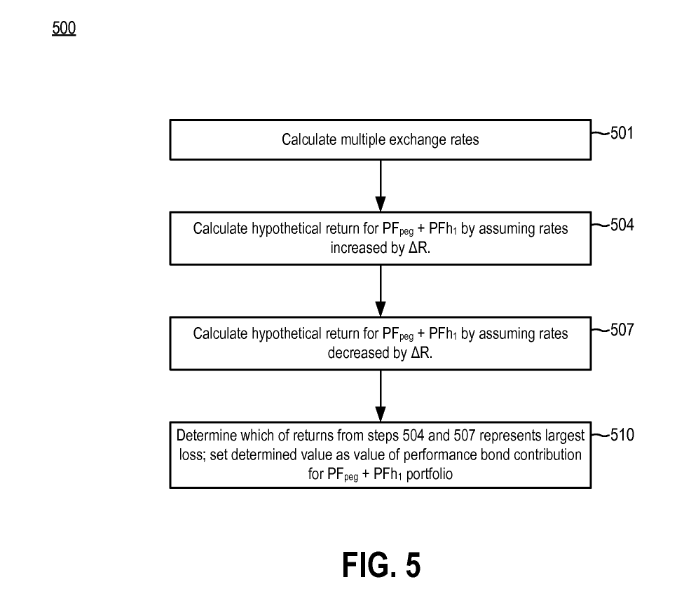

In some embodiments, module 140 performs artificial shocking in step 416 using the method 500 of FIG. 5. In step 501 of method 500, module 140 calculates multiple exchange rates by assuming that the exchange rate for products having tenors Mᵢ may rise by a fixed amount +ΔR (e.g., 8%) and may fall by an opposite amount −ΔR (e.g., −8%).

Continuing the earlier example of tables 1 and 3, and assuming current EURDKK exchange rates for tenors M₁ and M₂ of R_{EURDKK-1} and R_{EURDKK-2}, module 140 would calculate exemplary rates shown in table 5.

TABLE 5
example artificially shocked rates

| Tenor | Rates |
|---|---|
| M₁ | exp(ΔR)*R_{EURDKK-1}, exp(−ΔR)*R_{EURDKK-1} |
| | (e.g., exp(.08)*R_{EURDKK-1}, exp(−.08)*R_{EURDKK-1}) |
| M₂ | exp(ΔR)*R_{EURDKK-2}, exp(−ΔR)*R_{EURDKK-2} |
| | (e.g., exp(.08)*R_{EURDKK-2}, exp(−.08)*R_{EURDKK-2}) |

In step 504, module 140 calculates a hypothetical return in USD (using current USD exchange rates and applicable discount factors) for the PF_{peg}+PFh₁ portfolio. Module 140 calculates this return by assuming the portfolio was acquired at current exchange rates and liquidated at the current rates as increased by ΔR. In the example of tables 1, 3 and 5, the liquidation rates would be exp(ΔR)*R_{EURDKK-1} for the equivalent EURDKK product with tenor M₁ in the combined PF_{peg}+PFh₁ portfolio (i.e., a product with a notional of N₁+N₁/R₁) and exp(ΔR)*R_{EURDKK-2} for the equivalent EURDKK product with tenor M₂ in the combined PF_{peg}+PFh₁ portfolio (i.e., a product with a notional of N₂+N₂/R₂).

In step 507, module 140 calculates a second hypothetical return in USD (using current USD exchange rates and applicable discount factors) for the PF_{peg}+PFh₁ portfolio. Module 140 calculates the second hypothetical return by assuming the portfolio was acquired at current exchange rates and liquidated at the current rates as decreased by ΔR. In the example of tables 1, 3 and 5, the liquidation rates would be exp(−ΔR)*R_{EURDKK-1} for the equivalent EURDKK product(s) with tenor M₁ in the combined PF_{peg}+PFh₁ portfolio and exp(−ΔR)*R_{EURDKK-2} for the equivalent EURDKK product(s) with tenor M₂ in the combined PF_{peg}+PFh₁ portfolio.

In step 510, module 140 determines which of the returns from steps 504 and 507 represents the largest loss and sets that determined value as the value of the performance bond contribution for the PF_{peg}+PFh₁ portfolio.

In other embodiments of method 500, module 140 may use a different model to calculate the rates used to artificially shock the PF_{peg}+PFh₁ portfolio. Instead of using a constant value of ΔR, the value of ΔR could vary based on tenor of the products in the PF_{peg}+PFh₁ portfolio. For example, values for +ΔR and −ΔR could be based on equations 12a and 12b:

+ΔR=R₀+(R₁−R₀)*t(y)/t(y) Equation 12a:

−ΔR=−R₀−(R₁−R₀)*t(y)/t(y) Equation 12b:

In equations 12a and 12b, y′ represents the tenor of the product, t(y) represents the time from the current date until the maturity date associated with tenor y, and t(y′) represents the time from the current date until the maturity date associated with tenor y′, with y assumed to be the largest available tenor (e.g., 2 years). Example values for R₀ and R₁ and in equations 12a and 12b include 0.08 (8%) and 0.035 (3.5%), respectively. Continuing with the earlier examples from tables 1 and 3, assuming a single product with tenor M₁ and a single product with tenor M₂ in the PF_{peg}+PFh₁ portfolio, example artificially shocked rates based on equations 12a and 12b are as shown in table 6.

TABLE 6

| Tenor | Rates |
|---|---|
| M₁ | exp(R₀ + (R₁ − R₀)* t(M₁)/t(*y))*R_{EURDKK-1}, |
| | exp(−R₀ − (R₁ − R₀)* t(M₁)/t(y))*R_{EURDKK-1} |
| | (e.g., exp(0.08 + (0.035 − 0.08)* t(M₁)/t(y))*R_{EURDKK-1}, |
| | exp(−0.08 − (0.035 − 0.08)* t(M₁)/t(y))*R_{EURDKK-1}) |
| M₂ | exp(R₀ + (R₁ − R₀)* t(M₂)/t(y))*R_{EURDKK-2}, |
| | exp(−R₀ − (R₁ − R₀)* t(M₂)/t(y))*R_{EURDKK-2} |
| | (e.g., exp(0.08 + (0.035 − 0.08)* t(M₂)/t(y))*R_{EURDKK-2}, |
| | exp(−0.08 − (0.035 − 0.08)* t(M₂)/t(y))*R_{EURDKK-2}) |

In some embodiments, module 140 calculates hypothetical returns for the PF_{peg}+PFh₁ portfolio using fixed values of ΔR and −ΔR, calculates additional hypothetical returns for the PF_{peg}+PFh₁ portfolio using variable values for ΔR and −ΔR such as in equations 12a and 12b, and/or calculates still other hypothetical returns for the PF_{peg}+PFh₁ portfolio using variable values for ΔR and −ΔR such as in equations 12a and 12b, but with other values for R₀ and/or R₁ (e.g., by reversing the values of R₀ and R₁ such that R₀=0.035 and R₁=0.08). Module 140 may then determine which of those six hypothetical returns represents the largest loss and set that determined value as the value of the performance bond contribution for the PF_{peg}+PFh₁ portfolio.

Returning to FIG. 4, in step 423 module 140 combines the performance bond contribution calculated in step 416 with the performance bond contribution calculated in step 413. At step 440, data indicating the performance bond contribution amount from step 423 is passed to step 163 of method 150. Step 163 is discussed below.

Returning to step 429, and if there are any holdings based on pegged component currency pairs in which C_{ref}=C_{npeg}, a performance bond contribution for those holdings is computed using artificial shocking. The artificial shocking of step 429 is similar to that of step 416. For pegged component currency pairs in which C_{ref}=C_{npeg}, there is no need to create separate hypothetical portfolios. In step 440, any performance bond contribution amount from step 429 is also passed to step 163 of method 150.

Returning to FIG. 1B, in step 163 module 140 receives data indicating the performance bond contributions calculated using methods 200, 300 and/or 400. Module 140 then sums these contributions to obtain a performance bond value for the portfolio. In step 166, module 140 outputs data indicating the calculated performance bond value to other modules and/or computer systems for further operations. For example, another module of system 100 (and/or another computer system) may confirm that the holder of the portfolio has sufficient deposited funds or other account assets to provide the calculated total performance bond amount. If necessary, one or more communications could be generated and transmitted to the holder (or to an entity representing the holder) advising that additional funds or other assets are needed to satisfy the total performance bond requirement.

In the example used to describe steps 407-416, USD was the base currency in the subject pegged component currency pair. If USD is the quote currency in a subject pegged component currency pair (e.g., DKKUSD), the operations of method 400 could be adapted accordingly (e.g., hypothetical portfolios PFh₁ and PFh₂ may be based on the pair USDEUR instead of the pair EURUSD).

Other embodiments may include features in addition to and/or instead of features described above. Various above-described method steps can be combined, rearranged, omitted and/or performed in a different manner and/or additional steps may be included. As but one example thereof, certain steps of method 200 (e.g., steps 202 through 217) could be performed prior to receipt of data regarding a specific portfolio. As but another example thereof, certain steps of method 300 (e.g., 302A through 318) could be performed prior to receipt of data regarding a specific portfolio. Method 200, method 300 and/or method 400 could be combined with other methods to determine a value for a performance bond, e.g., for a portfolio that includes holdings in products not based on a currency pair. Any single one of method 200, method 300 or method 400 could be performed without performing the other methods (e.g., if a portfolio only includes products based on a single currency pair).

In some embodiments, various features described herein are not utilized or may be utilized in modified form. As but one example, a volatility floor is not used in certain embodiments. As but another example, certain embodiments calculate volatilities using alternate methodologies.

Additional embodiments include, without limitation, a method that comprises accessing exchange rate data for first and second currency pairs. The first currency pair may comprise a first currency and second currency and the second currency pair may comprise a third currency and the second currency. The exchange rate data may comprise values for the first currency in terms of the second currency and values for the third currency in terms of the second currency. The method may further comprise generating a first set of modified rates for the first currency pair based at least in part on the accessed exchange data, generating a second set of modified rates for the second currency pair based at least in part on the accessed exchange rate data, and generating a third set of modified rates based on the first and second sets of modified rates. The method may further comprise calculating a series of returns, using the third series of modified rates, associated with one or more products based on a third currency pair that includes the first and the third currency. The method may also comprise calculating a performance bond contribution based at least in part on the series of returns. Embodiments further include computer systems configured to perform such methods, and computer-readable media storing instructions that, when executed, cause a computer system to perform such methods.

Still further embodiments include a method that comprises receiving portfolio data. The portfolio data may identify at least one holding in at least one product that is based on a pegged component currency pair. The pegged component currency pair may comprise a pegged currency and a non-pegged currency. The pegged currency may have a value pegged to a value of a reference currency. The reference currency may be different from the non-pegged currency. The method may further comprise generating data representing first and second hypothetical portfolios. The first hypothetical portfolio may include a hypothetical holding in a product based on a currency pair that comprises the non-pegged currency and the reference currency. The second hypothetical portfolio may include a hypothetical holding in a product based on a currency pair that comprise the non-pegged currency and the reference currency. The method may further include determining a performance bond contribution applicable to a portfolio that includes the first hypothetical portfolio using one method and determining a performance bond contribution applicable to a portfolio that includes the second hypothetical portfolio using a different method. Embodiments further include computer systems configured to perform such methods, and computer-readable media storing instructions that, when executed, cause a computer system to perform such methods.

### CONCLUSION

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. For example, one of ordinary skill in the art will appreciate that some steps illustrated in the figures may be performed in other than the recited order, and that one or more steps illustrated may be optional in one or more embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. (canceled)

2. A method comprising the following steps performed by a computer system:
(a) calculating scaling factor matrices, wherein
each of the scaling factor matrices corresponds to a different one of multiple primary currency pairs,
each of the primary currency pairs includes a first currency as either a base currency or a quote currency,
each of the elements of each of the scaling factor matrices is a value representable as C_{x,y}, with x being an index to one of multiple different times, with y being an index to one of multiple different tenors for products based on the corresponding primary currency pair, and with C being a value for a scaling factor corresponding to an indexed time x and to an indexed tenor y, and
as to each primary currency pair, each C_{x,y} value in the corresponding scaling factor matrix also corresponds to the primary currency pair and is calculated according to
$$\frac{max ( {σ}_{T , y} , {σ}_{Floor} )}{{σ}_{x , y}} ,$$
with σ_{x,y} being a volatility value corresponding to an exchange rate for the primary currency pair, to the time corresponding to the calculated C_{x,y} value, and to the tenor corresponding to the calculated C_{x,y} value, with T being a current time, and with σ_{Floor} being a value equal to a predetermined percentile of all the volatility values corresponding to the exchange rates for the primary currency pair;
(b) calculating shocked exchange rate matrices, wherein
each of the shocked exchange rate matrices corresponds to a different one of the primary currency pairs,
each of the elements of each of the shocked exchange rate matrices is a value representable as SC_{x,y}, with SC being a value for a shocked exchange rate corresponding to an indexed time x and to an indexed tenor y, and
as to each primary currency pair, each SC_{x,y} value in the corresponding shocked exchange rate matrix also corresponds to the primary currency pair and is calculated based on the C_{x,y} value corresponding to the primary currency pair and to the time and to the tenor to which the calculated SC_{x,y} value correspond;
(c) parsing data for a portfolio that includes products based on currency pairs and identifying the currency pair on which each of the products is based;
(d) determining, based on the identified currency pairs, how performance bond contributions for products based on the identified currency pairs will be calculated;
(e) calculating shocked returns for a first group of the products, wherein each of the first group products is based on a currency pair in a first subset of the identified currency pairs, wherein each of the first subset currency pairs is one of the primary currency pairs and does not include a pegged currency, and wherein the shocked returns for the first group are based on the shocked exchange rate matrices corresponding to the first subset currency pairs;
(f) calculating shocked returns for a second group of the products, wherein each of the second group products is based on a currency pair in a second subset of the identified currency pairs, wherein each of the second subset currency pairs does not include the first currency, does not include a pegged currency, and includes currencies from two of the primary currency pairs, wherein the shocked returns for the second group are based on the matrices of shocked exchange rates corresponding to currency pairs of the primary currency pairs that include one of the second subset currencies;
(g) calculating shocked returns for a third group of the products, wherein each of the third group products is based on one of the currency pairs in a third subset of the identified currency pairs, wherein each of the third subset currency pairs includes a non-pegged currency and a pegged currency having a value artificially tied to a value of a reference currency different from the non-pegged currency, wherein the shocked returns for the third group are based on hypothetical portfolios corresponding to the third subset currency pairs, wherein the hypothetical portfolios for each third subset currency pair include hypothetical holdings in products based on a currency pair comprising the non-pegged currency of the third subset currency pair and the reference currency of the third subset currency pair;
(h) calculating a performance bond contribution based on the calculations of steps (e), (f), and (g);
(i) determining whether an account associated with the portfolio contains sufficient assets to provide an amount from step (h); and
(j) transmitting, based on the determination of step (i), one or more communications advising that additional assets are needed to satisfy a performance bond requirement.

3. The method of claim 2, wherein
step (a) comprises calculating log rate matrices, each of the log rate matrices corresponding to a different one of the primary currency pairs,
each of the elements of each of the log rate matrices is a value representable as r_{x,y}, with r being a value for a log exchange rate corresponding to an indexed time x and to an indexed tenor y,
as to each primary currency pair, each r_{x,y} value in the corresponding log rate matrix also corresponds to the primary currency pair and is calculated according to log((R_{x,y})/(R_{x-l,y})), with R_{x,y} being an exchange rate value corresponding to the primary currency pair, to the time corresponding to the calculated r_{x,y} value, and to the tenor corresponding to the calculated r_{x,y} value, and with l being a predetermined number of time periods,
step (a) comprises calculating volatility matrices, each of the volatility matrices corresponding to a different one of the primary currency pairs,
each of the elements of each of the volatility matrices is a value representable as σ_{x,y}, with σ being a value for a volatility corresponding to an indexed time x and to an indexed tenor y, and
as to each primary currency pair, each value σ_{x,y} in the corresponding volatility matrix also corresponds to the primary currency pair and, for x>1, is calculated according to \sqrt{(1−λ)*r_{x-1,y}²+λ*σ_{x-1,y}²}, with λ being a predetermined time decay coefficient, and with σ_{1,y} being seeded based on exponentially weighted moving average calculations based on data corresponding to times prior to x=1.

4. The method of claim 3, wherein as to each of the primary currency pairs, each of the SC_{x,y} values corresponding to the primary currency pair is calculated according to R_{T,y}*exp(r_{x,y}*C_{x,y}), with R_{T,y} being an exchange rate value corresponding to the primary currency pair, to a current time T, and to tenor to which the calculated SC_{x,y} value corresponds, with r_{x,y} being the log exchange rate value corresponding to the primary currency pair, to the time to which the calculated SC_{x,y} value corresponds, and to the tenor to which the calculated SC_{x,y} value corresponds, and with C_{x,y} being the scaling factor value corresponding to the primary currency pair, to the time to which the calculated SC_{x,y} value corresponds, and to the tenor to which the calculated SC_{x,y} value corresponds.

5. The method of claim 4, wherein
step (e) comprises calculating shocked return arrays,
each of the shocked return arrays corresponds to a different one of the first subset currency pairs,
each of the elements of each of the shocked return arrays is a value representable as SRₓ, with SR being a value for a shocked return corresponding to an indexed time x,
as to each first subset currency pair, each SRₓ value in the corresponding shocked return array also corresponds to the first subset currency pair and represents a shocked return corresponding to first group products based on the first subset currency pair and is calculated according to
$${\sum }_{j = 1}^{n} [ {N}_{j} * ( {iSC}_{x , y ( j )} - {iR}_{T , y ( j )} ) * CF * {DF}_{x}^{CU 1} ] ,$$
with n being a number of first group products based on the first subset currency pair,
with Nⱼ being a notional value of the j^{th} first group product based on the first subset currency pair,
with y(j) being the tenor of the j^{th} first group product based on the first subset currency pair,
with iSC_{x,y(j)} being either (1) the element SC_{x,y} of the shocked exchange rate matrix corresponding to the first subset currency pair, to the time to which the calculated SRₓ value corresponds, and to the tenor of the j^{th} first group product based on the first subset currency pair, if y(j) is aligned with one of the tenors of that shocked exchange rate matrix, or (2) a value interpolated from elements of the shocked exchange rate matrix that corresponds to the time to which the calculated SRₓ value corresponds and to other tenors of the j^{th} first group product, if y(j) is not aligned with one of the tenors of that shocked exchange rate matrix,
with iR_{T,y(j)} being a current market rate for products based on the first subset currency pair and having tenor y(j),
with CF being either 1, if the primary currency is the quote currency of the first subset currency pair, or 1/iSC_{x,y(j)}, if the primary currency is the base currency of the first subset currency pair, and
with DFₓ^{CU1} being a discount factor to account for a time difference between a product maturity date and a current date, and
step (e) comprises creating an array of shocked return sums by summing, for each of the indexed times, the values corresponding to the indexed time from each of the shocked return arrays.

6. The method of claim 5, wherein
step (f) comprises calculating cross pair shocked exchange rate matrices,
each of the cross pair shocked exchange rate matrices corresponds to a different one of the second subset currency pairs,
each of the elements in each of the cross pair shocked exchange rate matrices is a value representable as SC_{x,y}^{CP1CP2}, with SC^{CP1CP2} being a value for a shocked exchange rate corresponding to an indexed time x and to an indexed tenor y,
as to each second subset currency pair, each SC^{CP1CP2} value in the corresponding cross pair shocked exchange rate matrix also corresponds to the second subset currency pair and is calculated according to R_{T,y}*exp(sr_{x,y}(CP1CU1)−sr_{x,y}(CP2CU1)),
with R_{T,y} being a current market rate for products based on the second subset currency pair and having the tenor to which the calculated SC^{CP1CP2} value corresponds,
with sr_{x,y}(CP1CU1) being the product of (1) the element r_{x,y} of the log rate matrix corresponding to the primary currency pair having the base currency CP1 of the second subset currency pair as a base currency and the first currency CU1 as the quote currency, to the time to which the calculated SC^{CP1CP2} value corresponds, and to the tenor to which the calculated SC^{CP1CP2} value corresponds, and (2) the element C_{x,y} of the scaling factor matrix corresponding to the primary currency pair having the base currency CP1 of the second subset currency pair as a base currency and the first currency CU1 as the quote currency, to the time to which the calculated SC^{CP1CP2} value corresponds, and to the tenor to which the calculated SC^{CP1CP2} value corresponds, and
with sr_{x,y}(CP2CU1) being the product of (1) the element r_{x,y} of the log rate matrix corresponding to the primary currency pair having the quote currency CP2 of the second subset currency pair as a base currency and the first currency CU1 as the quote currency, to the time to which the calculated SC^{CP1CP2} value corresponds, and to the tenor to which the calculated SC^{CP1CP2} value corresponds, and (2) the element C_{x,y} of the scaling factor matrix corresponding to the primary currency pair having the quote currency CP2 of the second subset currency pair as a base currency and the first currency CU1 as the quote currency, to the time to which the calculated SC^{CP1CP2} value corresponds, and to the tenor to which the calculated SC^{CP1CP2} value corresponds.

7. The method of claim 6, wherein
step (f) comprises calculating cross pair shocked return arrays,
each of the shocked return arrays corresponds to a different one of the second subset currency pairs,
each of the elements of each of the shocked return arrays is a value representable as CSRₓ, with CSR being a value for a shocked return corresponding to an indexed time x,
as to each second subset currency pair, each CSRₓ value in the corresponding cross pair shocked return array also corresponds to the second subset currency pair and represents a shocked return corresponding to second group products based on the second subset currency pair and is calculated according to
$${\sum }_{j = 1}^{n} [ {N}_{j} * ( {iSC}_{x , y ( j )}^{CP 1 CP 2} - {iR}_{T , y ( j )} ) * {SC}_{x , y ( j )}^{CP 2 CU 1} * {DF}_{x}^{CU 1} ] ,$$
with n being a number of second group products based on the second subset currency pair,
with Nⱼ being a notional value of the j^{th} second group product based on the second subset currency pair,
with y(j) being the tenor of the j^{th} second group product based on the second subset currency pair,
with iSC_{x,y(j)}^{CP1CP2} being either (1) the element of the cross pair shocked exchange rate matrix corresponding to the second subset currency pair, to the time to which the calculated CSRₓ value corresponds, and to the tenor of the j^{th} second group product based on the second subset currency pair, if y(j) is aligned with one of the tenors of that cross pair shocked exchange rate matrix, or (2) a value interpolated from elements of that shocked exchange rate matrix that are indexed to the time to which the calculated CSRₓ value corresponds and to other tenors of the j^{th} second group product based on the second subset currency pair, if y(j) is not aligned with one of the tenors of that shocked exchange rate matrix,
with iR_{T,y(j)} being a current market rate for products based on the second subset currency pair and having tenor y(j), and
with SC_{x,y(j)}^{CP2CU1} being either (1) the element, of the shocked exchange rate matrix corresponding to the primary currency pair having the quote currency CP2 of the second subset currency pair as a base currency and the first currency CU1 as the quote currency, corresponding to the time to which the calculated CSRₓ value corresponds, and to the tenor of the j^{th} first group product based on the second subset currency pair, if y(j) is aligned with one of the tenors of that shocked exchange rate matrix, or (2) a value interpolated from elements of that shocked exchange rate matrix that are indexed to the time to which the calculated CSRₓ value corresponds and to other tenors of the j^{th} second group product based on the second subset currency pair, if y(j) is not aligned with one of the tenors of that shocked exchange rate matrix, and
step (f) comprises creating an array of cross pair shocked return sums by summing, for each of the indexed times, the values for the indexed time from each of the cross pair shocked return arrays.

8. The method of claim 7, wherein step (h) comprises
creating a second array of shocked return sums by summing, for each of the indexed times, the values for the indexed time from the array of shocked return sums and from the array of cross pair shocked return sums,
sorting the sums in the second array of shocked return sums from highest to lowest,
identifying a value within the sorted sums that corresponds to a predetermined percentile, and
designating a performance bond contribution based on the identified value.

9. A computer system comprising:
at least one processor; and
at least one non-transitory memory, wherein the at least one non-transitory memory stores instructions that, when executed, cause the computer system to perform operations that include
(a) calculating scaling factor matrices, wherein
each of the scaling factor matrices corresponds to a different one of multiple primary currency pairs,
each of the primary currency pairs includes a first currency as either a base currency or a quote currency,
each of the elements of each of the scaling factor matrices is a value representable as C_{x,y}, with x being an index to one of multiple different times, with y being an index to one of multiple different tenors for products based on the corresponding primary currency pair, and with C being a value for a scaling factor corresponding to an indexed time x and to an indexed tenor y, and
as to each primary currency pair, each C_{x,y} value in the corresponding scaling factor matrix also corresponds to the primary currency pair and is calculated according to
$$\frac{max ( {σ}_{T , y} , {σ}_{Floor} )}{{σ}_{x , y}} ,$$
with σ_{x,y} being a volatility value corresponding to an exchange rate for the primary currency pair, to the time corresponding to the calculated C_{x,y} value, and to the tenor corresponding to the calculated C_{x,y} value, with T being a current time, and with σ_{Floor} being a value equal to a predetermined percentile of all the volatility values corresponding to the exchange rates for the primary currency pair;
(b) calculating shocked exchange rate matrices, wherein
each of the shocked exchange rate matrices corresponds to a different one of the primary currency pairs,
each of the elements of each of the shocked exchange rate matrices is a value representable as SC_{x,y}, with SC being a value for a shocked exchange rate corresponding to an indexed time x and to an indexed tenor y, and
as to each primary currency pair, each SC_{x,y} value in the corresponding shocked exchange rate matrix also corresponds to the primary currency pair and is calculated based on the C_{x,y} value corresponding to the primary currency pair and to the time and to the tenor to which the calculated SC_{x,y} value correspond;
(c) parsing data for a portfolio that includes products based on currency pairs and identifying the currency pair on which each of the products is based;
(d) determining, based on the identified currency pairs, how performance bond contributions for products based on the identified currency pairs will be calculated;
(e) calculating shocked returns for a first group of the products, wherein each of the first group products is based on a currency pair in a first subset of the identified currency pairs, wherein each of the first subset currency pairs is one of the primary currency pairs and does not include a pegged currency, and wherein the shocked returns for the first group are based on the shocked exchange rate matrices corresponding to the first subset currency pairs;
(f) calculating shocked returns for a second group of the products, wherein each of the second group products is based on a currency pair in a second subset of the identified currency pairs, wherein each of the second subset currency pairs does not include the first currency, does not include a pegged currency, and includes currencies from two of the primary currency pairs, wherein the shocked returns for the second group are based on the matrices of shocked exchange rates corresponding to currency pairs of the primary currency pairs that include one of the second subset currencies;
(g) calculating shocked returns for a third group of the products, wherein each of the third group products is based on one of the currency pairs in a third subset of the identified currency pairs, wherein each of the third subset currency pairs includes a non-pegged currency and a pegged currency having a value artificially tied to a value of a reference currency different from the non-pegged currency, wherein the shocked returns for the third group are based on hypothetical portfolios corresponding to the third subset currency pairs, wherein the hypothetical portfolios for each third subset currency pair include hypothetical holdings in products based on a currency pair comprising the non-pegged currency of the third subset currency pair and the reference currency of the third subset currency pair;
(h) calculating a performance bond contribution based on the calculations of steps (e), (f), and (g);
(i) determining whether an account associated with the portfolio contains sufficient assets to provide an amount from step (h); and
(j) transmitting, based on the determination of step (i), one or more communications advising that additional assets are needed to satisfy a performance bond requirement.

10. The computer system of claim 9, wherein
step (a) comprises calculating log rate matrices, each of the log rate matrices corresponding to a different one of the primary currency pairs,
each of the elements of each of the log rate matrices is a value representable as r_{x,y}, with r being a value for a log exchange rate corresponding to an indexed time x and to an indexed tenor y,
as to each primary currency pair, each r_{x,y} value in the corresponding log rate matrix also corresponds to the primary currency pair and is calculated according to log((R_{x,y})/(R_{x-l,y})), with R_{x,y} being an exchange rate value corresponding to the primary currency pair, to the time corresponding to the calculated r_{x,y} value, and to the tenor corresponding to the calculated r_{x,y} value, and with l being a predetermined number of time periods,
step (a) comprises calculating volatility matrices, each of the volatility matrices corresponding to a different one of the primary currency pairs,
each of the elements of each of the volatility matrices is a value representable as σ_{x,y}, with σ being a value for a volatility corresponding to an indexed time x and to an indexed tenor y, and
as to each primary currency pair, each value σ_{x,y} in the corresponding volatility matrix also corresponds to the primary currency pair and, for x>1, is calculated according to \sqrt{(1−λ)*r_{x-1,y}²+λ*σ_{x-1,y}²}, with λ being a predetermined time decay coefficient, and with σ_{1,y} being seeded based on exponentially weighted moving average calculations based on data corresponding to times prior to x=1.

11. The computer system of claim 10, wherein as to each of the primary currency pairs, each of the SC_{x,y} values corresponding to the primary currency pair is calculated according to R_{T,y}*exp(r_{x,y}*C_{x,y}), with R_{T,y} being an exchange rate value corresponding to the primary currency pair, to a current time T, and to tenor to which the calculated SC_{x,y} value corresponds, with r_{x,y} being the log exchange rate value corresponding to the primary currency pair, to the time to which the calculated SC_{x,y} value corresponds, and to the tenor to which the calculated SC_{x,y} value corresponds, and with C_{x,y} being the scaling factor value corresponding to the primary currency pair, to the time to which the calculated SC_{x,y} value corresponds, and to the tenor to which the calculated SC_{x,y} value corresponds.

12. The computer system of claim 11, wherein
step (e) comprises calculating shocked return arrays,
each of the shocked return arrays corresponds to a different one of the first subset currency pairs,
each of the elements of each of the shocked return arrays is a value representable as SRₓ, with SR being a value for a shocked return corresponding to an indexed time x,
as to each first subset currency pair, each SRₓ value in the corresponding shocked return array also corresponds to the first subset currency pair and represents a shocked return corresponding to first group products based on the first subset currency pair and is calculated according to
$${\sum }_{j = 1}^{n} [ {N}_{j} * ( {iSC}_{x , y ( j )} - {iR}_{T , y ( j )} ) * CF * {DF}_{x}^{CU 1} ] ,$$
with n being a number of first group products based on the first subset currency pair,
with Nⱼ being a notional value of the j^{th} first group product based on the first subset currency pair,
with y(j) being the tenor of the j^{th} first group product based on the first subset currency pair,
with iSC_{x,y(j)} being either (1) the element SC_{x,y} of the shocked exchange rate matrix corresponding to the first subset currency pair, to the time to which the calculated SRₓ value corresponds, and to the tenor of the j^{th} first group product based on the first subset currency pair, if y(j) is aligned with one of the tenors of that shocked exchange rate matrix, or (2) a value interpolated from elements of the shocked exchange rate matrix that corresponds to the time to which the calculated SRₓ value corresponds and to other tenors of the j^{th} first group product, if y(j) is not aligned with one of the tenors of that shocked exchange rate matrix,
with iR_{T,y(j)} being a current market rate for products based on the first subset currency pair and having tenor y(j),
with CF being either 1, if the primary currency is the quote currency of the first subset currency pair, or 1/iSC_{x,y(j)}, if the primary currency is the base currency of the first subset currency pair, and
with DFₓ^{CU1} being a discount factor to account for a time difference between a product maturity date and a current date, and
step (e) comprises creating an array of shocked return sums by summing, for each of the indexed times, the values corresponding to the indexed time from each of the shocked return arrays.

13. The computer system of claim 12, wherein
step (f) comprises calculating cross pair shocked exchange rate matrices,
each of the cross pair shocked exchange rate matrices corresponds to a different one of the second subset currency pairs,
each of the elements in each of the cross pair shocked exchange rate matrices is a value representable as SC_{x,y}^{CP1CP2}, with SC^{CP1CP2} being a value for a shocked exchange rate corresponding to an indexed time x and to an indexed tenor y,
as to each second subset currency pair, each SC^{CP1CP2} value in the corresponding cross pair shocked exchange rate matrix also corresponds to the second subset currency pair and is calculated according to R_{T,y}*exp(sr_{x,y}(CP1CU1)−sr_{x,y}(CP2CU1)),
with R_{T,y} being a current market rate for products based on the second subset currency pair and having the tenor to which the calculated SC^{CP1CP2} value corresponds,
with sr_{x,y}(CP1CU1) being the product of (1) the element r_{x,y} of the log rate matrix corresponding to the primary currency pair having the base currency CP1 of the second subset currency pair as a base currency and the first currency CU1 as the quote currency, to the time to which the calculated SC^{CP1CP2} value corresponds, and to the tenor to which the calculated SC^{CP1CP2} value corresponds, and (2) the element C_{x,y} of the scaling factor matrix corresponding to the primary currency pair having the base currency CP1 of the second subset currency pair as a base currency and the first currency CU1 as the quote currency, to the time to which the calculated SC^{CP1CP2} value corresponds, and to the tenor to which the calculated SC^{CP1CP2} value corresponds, and
with sr_{x,y}(CP2CU1) being the product of (1) the element r_{x,y} of the log rate matrix corresponding to the primary currency pair having the quote currency CP2 of the second subset currency pair as a base currency and the first currency CU1 as the quote currency, to the time to which the calculated SC^{CP1CP2} value corresponds, and to the tenor to which the calculated SC^{CP1CP2} value corresponds, and (2) the element C_{x,y} of the scaling factor matrix corresponding to the primary currency pair having the quote currency CP2 of the second subset currency pair as a base currency and the first currency CU1 as the quote currency, to the time to which the calculated SC^{CP1CP2} value corresponds, and to the tenor to which the calculated SC^{CP1CP2} value corresponds.

14. The computer system of claim 13, wherein
step (f) comprises calculating cross pair shocked return arrays,
each of the shocked return arrays corresponds to a different one of the second subset currency pairs,
each of the elements of each of the shocked return arrays is a value representable as CSRₓ, with CSR being a value for a shocked return corresponding to an indexed time x,
as to each second subset currency pair, each CSRₓ value in the corresponding cross pair shocked return array also corresponds to the second subset currency pair and represents a shocked return corresponding to second group products based on the second subset currency pair and is calculated according to
$${\sum }_{j = 1}^{n} [ {N}_{j} * ( {iSC}_{x , y ( j )}^{CP 1 CP 2} - {iR}_{T , y ( j )} ) * {SC}_{x , y ( j )}^{CP 2 CU 1} * {DF}_{x}^{CU 1} ] ,$$
with n being a number of second group products based on the second subset currency pair,
with Nⱼ being a notional value of the j^{th} second group product based on the second subset currency pair,
with y(j) being the tenor of the j^{th} second group product based on the second subset currency pair,
with iSC_{x,y(j)}^{CP1CP2} being either (1) the element of the cross pair shocked exchange rate matrix corresponding to the second subset currency pair, to the time to which the calculated CSRₓ value corresponds, and to the tenor of the j^{th} second group product based on the second subset currency pair, if y(j) is aligned with one of the tenors of that cross pair shocked exchange rate matrix, or (2) a value interpolated from elements of that shocked exchange rate matrix that are indexed to the time to which the calculated CSRₓ value corresponds and to other tenors of the j^{th} second group product based on the second subset currency pair, if y(j) is not aligned with one of the tenors of that shocked exchange rate matrix,
with iR_{T,y(j)} being a current market rate for products based on the second subset currency pair and having tenor y(j), and
with SC_{x,y(j)}^{CP2CU1} being either (1) the element, of the shocked exchange rate matrix corresponding to the primary currency pair having the quote currency CP2 of the second subset currency pair as a base currency and the first currency CU1 as the quote currency, corresponding to the time to which the calculated CSRₓ value corresponds, and to the tenor of the j^{th} first group product based on the second subset currency pair, if y(j) is aligned with one of the tenors of that shocked exchange rate matrix, or (2) a value interpolated from elements of that shocked exchange rate matrix that are indexed to the time to which the calculated CSRₓ value corresponds and to other tenors of the j^{th} second group product based on the second subset currency pair, if y(j) is not aligned with one of the tenors of that shocked exchange rate matrix, and
step (f) comprises creating an array of cross pair shocked return sums by summing, for each of the indexed times, the values for the indexed time from each of the cross pair shocked return arrays.

15. The computer system of claim 14, wherein step (h) comprises
creating a second array of shocked return sums by summing, for each of the indexed times, the values for the indexed time from the array of shocked return sums and from the array of cross pair shocked return sums,
sorting the sums in the second array of shocked return sums from highest to lowest,
identifying a value within the sorted sums that corresponds to a predetermined percentile, and
designating a performance bond contribution based on the identified value.

16. One or more non-transitory computer-readable media storing computer executable instructions that, when executed, cause a computer system to perform operations that include:
(a) calculating scaling factor matrices, wherein
each of the scaling factor matrices corresponds to a different one of multiple primary currency pairs,
each of the primary currency pairs includes a first currency as either a base currency or a quote currency,
each of the elements of each of the scaling factor matrices is a value representable as C_{x,y}, with x being an index to one of multiple different times, with y being an index to one of multiple different tenors for products based on the corresponding primary currency pair, and with C being a value for a scaling factor corresponding to an indexed time x and to an indexed tenor y, and
as to each primary currency pair, each C_{x,y} value in the corresponding scaling factor matrix also corresponds to the primary currency pair and is calculated according to
$$\frac{max ( {σ}_{T , y} , {σ}_{Floor} )}{{σ}_{x , y}} ,$$
with σ_{x,y} being a volatility value corresponding to an exchange rate for the primary currency pair, to the time corresponding to the calculated C_{x,y} value, and to the tenor corresponding to the calculated C_{x,y} value, with T being a current time, and with σ_{Floor} being a value equal to a predetermined percentile of all the volatility values corresponding to the exchange rates for the primary currency pair;
(b) calculating shocked exchange rate matrices, wherein
each of the shocked exchange rate matrices corresponds to a different one of the primary currency pairs,
each of the elements of each of the shocked exchange rate matrices is a value representable as SC_{x,y}, with SC being a value for a shocked exchange rate corresponding to an indexed time x and to an indexed tenor y, and
as to each primary currency pair, each SC_{x,y} value in the corresponding shocked exchange rate matrix also corresponds to the primary currency pair and is calculated based on the C_{x,y} value corresponding to the primary currency pair and to the time and to the tenor to which the calculated SC_{x,y} value correspond;
(c) parsing data for a portfolio that includes products based on currency pairs and identifying the currency pair on which each of the products is based;
(d) determining, based on the identified currency pairs, how performance bond contributions for products based on the identified currency pairs will be calculated;
(e) calculating shocked returns for a first group of the products, wherein each of the first group products is based on a currency pair in a first subset of the identified currency pairs, wherein each of the first subset currency pairs is one of the primary currency pairs and does not include a pegged currency, and wherein the shocked returns for the first group are based on the shocked exchange rate matrices corresponding to the first subset currency pairs;
(f) calculating shocked returns for a second group of the products, wherein each of the second group products is based on a currency pair in a second subset of the identified currency pairs, wherein each of the second subset currency pairs does not include the first currency, does not include a pegged currency, and includes currencies from two of the primary currency pairs, wherein the shocked returns for the second group are based on the matrices of shocked exchange rates corresponding to currency pairs of the primary currency pairs that include one of the second subset currencies;
(g) calculating shocked returns for a third group of the products, wherein each of the third group products is based on one of the currency pairs in a third subset of the identified currency pairs, wherein each of the third subset currency pairs includes a non-pegged currency and a pegged currency having a value artificially tied to a value of a reference currency different from the non-pegged currency, wherein the shocked returns for the third group are based on hypothetical portfolios corresponding to the third subset currency pairs, wherein the hypothetical portfolios for each third subset currency pair include hypothetical holdings in products based on a currency pair comprising the non-pegged currency of the third subset currency pair and the reference currency of the third subset currency pair;
(h) calculating a performance bond contribution based on the calculations of steps (e), (f), and (g);
(i) determining whether an account associated with the portfolio contains sufficient assets to provide an amount from step (h); and
(j) transmitting, based on the determination of step (i), one or more communications advising that additional assets are needed to satisfy a performance bond requirement.

17. The one or more non-transitory computer-readable media of claim 16, wherein
step (a) comprises calculating log rate matrices, each of the log rate matrices corresponding to a different one of the primary currency pairs,
each of the elements of each of the log rate matrices is a value representable as r_{x,y}, with r being a value for a log exchange rate corresponding to an indexed time x and to an indexed tenor y,
as to each primary currency pair, each r_{x,y} value in the corresponding log rate matrix also corresponds to the primary currency pair and is calculated according to log((R_{x,y})/(R_{x-l,y})), with R_{x,y} being an exchange rate value corresponding to the primary currency pair, to the time corresponding to the calculated r_{x,y} value, and to the tenor corresponding to the calculated r_{x,y} value, and with l being a predetermined number of time periods,
step (a) comprises calculating volatility matrices, each of the volatility matrices corresponding to a different one of the primary currency pairs,
each of the elements of each of the volatility matrices is a value representable as σ_{x,y}, with σ being a value for a volatility corresponding to an indexed time x and to an indexed tenor y, and
as to each primary currency pair, each value σ_{x,y} in the corresponding volatility matrix also corresponds to the primary currency pair and, for x>1, is calculated according to \sqrt{(1−λ)*r_{x-1,y}²+λ*σ_{x-1,y}²}, with λ being a predetermined time decay coefficient, and with σ_{1,y} being seeded based on exponentially weighted moving average calculations based on data corresponding to times prior to x=1.

18. The one or more non-transitory computer-readable media of claim 17, wherein as to each of the primary currency pairs, each of the SC_{x,y} values corresponding to the primary currency pair is calculated according to R_{T,y}*exp(r_{x,y}*C_{x,y}), with R_{T,y} being an exchange rate value corresponding to the primary currency pair, to a current time T, and to tenor to which the calculated SC_{x,y} value corresponds, with r_{x,y} being the log exchange rate value corresponding to the primary currency pair, to the time to which the calculated SC_{x,y} value corresponds, and to the tenor to which the calculated SC_{x,y} value corresponds, and with C_{x,y} being the scaling factor value corresponding to the primary currency pair, to the time to which the calculated SC_{x,y} value corresponds, and to the tenor to which the calculated SC_{x,y} value corresponds.

19. The one or more non-transitory computer-readable media of claim 18, wherein
step (e) comprises calculating shocked return arrays,
each of the shocked return arrays corresponds to a different one of the first subset currency pairs,
each of the elements of each of the shocked return arrays is a value representable as SRₓ, with SR being a value for a shocked return corresponding to an indexed time x,
as to each first subset currency pair, each SRₓ value in the corresponding shocked return array also corresponds to the first subset currency pair and represents a shocked return corresponding to first group products based on the first subset currency pair and is calculated according to
$${\sum }_{j = 1}^{n} [ {N}_{j} * ( {iSC}_{x , y ( j )} - {iR}_{T , y ( j )} ) * CF * {DF}_{x}^{CU 1} ] ,$$
with n being a number of first group products based on the first subset currency pair,
with Nⱼ being a notional value of the j^{th} first group product based on the first subset currency pair,
with y(j) being the tenor of the j^{th} first group product based on the first subset currency pair,
with iSC_{x,y(j)} being either (1) the element SC_{x,y} of the shocked exchange rate matrix corresponding to the first subset currency pair, to the time to which the calculated SRₓ value corresponds, and to the tenor of the j^{th} first group product based on the first subset currency pair, if y(j) is aligned with one of the tenors of that shocked exchange rate matrix, or (2) a value interpolated from elements of the shocked exchange rate matrix that corresponds to the time to which the calculated SRₓ value corresponds and to other tenors of the j^{th} first group product, if y(j) is not aligned with one of the tenors of that shocked exchange rate matrix,
with iR_{T,y(j)} being a current market rate for products based on the first subset currency pair and having tenor y(j),
with CF being either 1, if the primary currency is the quote currency of the first subset currency pair, or 1/iSC_{x,y(j)}, if the primary currency is the base currency of the first subset currency pair, and
with DFₓ^{CU1} being a discount factor to account for a time difference between a product maturity date and a current date, and
step (e) comprises creating an array of shocked return sums by summing, for each of the indexed times, the values corresponding to the indexed time from each of the shocked return arrays.

20. The one or more non-transitory computer-readable media of claim 19, wherein
step (f) comprises calculating cross pair shocked exchange rate matrices,
each of the cross pair shocked exchange rate matrices corresponds to a different one of the second subset currency pairs,
each of the elements in each of the cross pair shocked exchange rate matrices is a value representable as SC_{x,y}^{CP1CP2}, with SC^{CP1CP2} being a value for a shocked exchange rate corresponding to an indexed time x and to an indexed tenor y,
as to each second subset currency pair, each SC^{CP1CP2} value in the corresponding cross pair shocked exchange rate matrix also corresponds to the second subset currency pair and is calculated according to R_{T,y}*exp(sr_{x,y}(CP1CU1)−sr_{x,y}(CP2CU1)),
with R_{T,y} being a current market rate for products based on the second subset currency pair and having the tenor to which the calculated SC^{CP1CP2} value corresponds,
with sr_{x,y}(CP1CU1) being the product of (1) the element r_{x,y} of the log rate matrix corresponding to the primary currency pair having the base currency CP1 of the second subset currency pair as a base currency and the first currency CU1 as the quote currency, to the time to which the calculated SC^{CP1CP2} value corresponds, and to the tenor to which the calculated SC^{CP1CP2} value corresponds, and (2) the element C_{x,y} of the scaling factor matrix corresponding to the primary currency pair having the base currency CP1 of the second subset currency pair as a base currency and the first currency CU1 as the quote currency, to the time to which the calculated SC^{CP1CP2} value corresponds, and to the tenor to which the calculated SC^{CP1CP2} value corresponds, and
with sr_{x,y}(CP2CU1) being the product of (1) the element r_{x,y} of the log rate matrix corresponding to the primary currency pair having the quote currency CP2 of the second subset currency pair as a base currency and the first currency CU1 as the quote currency, to the time to which the calculated SC^{CP1CP2} value corresponds, and to the tenor to which the calculated SC^{CP1CP2} value corresponds, and (2) the element C_{x,y} of the scaling factor matrix corresponding to the primary currency pair having the quote currency CP2 of the second subset currency pair as a base currency and the first currency CU1 as the quote currency, to the time to which the calculated SC^{CP1CP2} value corresponds, and to the tenor to which the calculated SC^{CP1CP2} value corresponds.

21. The one or more non-transitory computer-readable media of claim 20, wherein
step (f) comprises calculating cross pair shocked return arrays,
each of the shocked return arrays corresponds to a different one of the second subset currency pairs,
each of the elements of each of the shocked return arrays is a value representable as CSRₓ, with CSR being a value for a shocked return corresponding to an indexed time x,
as to each second subset currency pair, each CSRₓ value in the corresponding cross pair shocked return array also corresponds to the second subset currency pair and represents a shocked return corresponding to second group products based on the second subset currency pair and is calculated according to
$${\sum }_{j = 1}^{n} [ {N}_{j} * ( {iSC}_{x , y ( j )}^{CP 1 CP 2} - {iR}_{T , y ( j )} ) * {SC}_{x , y ( j )}^{CP 2 CU 1} * {DF}_{x}^{CU 1} ] ,$$
with n being a number of second group products based on the second subset currency pair,
with Nⱼ being a notional value of the j^{th} second group product based on the second subset currency pair,
with y(j) being the tenor of the j^{th} second group product based on the second subset currency pair,
with iSC_{x,y(j)}^{CP1CP2} being either (1) the element of the cross pair shocked exchange rate matrix corresponding to the second subset currency pair, to the time to which the calculated CSRₓ value corresponds, and to the tenor of the j^{th} second group product based on the second subset currency pair, if y(j) is aligned with one of the tenors of that cross pair shocked exchange rate matrix, or (2) a value interpolated from elements of that shocked exchange rate matrix that are indexed to the time to which the calculated CSRₓ value corresponds and to other tenors of the j^{th} second group product based on the second subset currency pair, if y(j) is not aligned with one of the tenors of that shocked exchange rate matrix,
with iR_{T,y(j)} being a current market rate for products based on the second subset currency pair and having tenor y(j), and
with SC_{x,y(j)}^{CP2CU1} being either (1) the element, of the shocked exchange rate matrix corresponding to the primary currency pair having the quote currency CP2 of the second subset currency pair as a base currency and the first currency CU1 as the quote currency, corresponding to the time to which the calculated CSRₓ value corresponds, and to the tenor of the j^{th} first group product based on the second subset currency pair, if y(j) is aligned with one of the tenors of that shocked exchange rate matrix, or (2) a value interpolated from elements of that shocked exchange rate matrix that are indexed to the time to which the calculated CSRₓ value corresponds and to other tenors of the j^{th} second group product based on the second subset currency pair, if y(j) is not aligned with one of the tenors of that shocked exchange rate matrix, and
step (f) comprises creating an array of cross pair shocked return sums by summing, for each of the indexed times, the values for the indexed time from each of the cross pair shocked return arrays.
